(19) United States
(12) Patent Application Publication
(10) Pub. No.: US 2025/0231147 A1
(43) Pub. Date: Jul. 17, 2025

(54) DEVICES AND METHODS FOR INSPECTION OF CONDUIT FITTING ASSEMBLIES

(71) Applicant: Swagelok Company, Solon, OH (US)

(72) Inventors: Cal R. Brown, Lyndhurst, OH (US); Ercan Balikci, Solon, OH (US); David Allan Hughes, Renfrewshire (GB); Daniel Irving, Glasgow (GB); Claire Thring, Paisley (GB); Neill Wight, Glasgow (GB); Daniel Cohen, Glasgow (GB)

(21) Appl. No.: 19/028,177

(22) Filed: Jan. 17, 2025

Related U.S. Application Data
(60) Provisional application No. 63/621,619, filed on Jan. 17, 2024.

(51) Int. Cl. G01N 29/04; G01N 29/22

(52) U.S. Cl. CPC G01N 29/041; G01N 29/221; G01N 29/223; F16L 2201/10

(57) ABSTRACT

In a method of inspecting a conduit fitting installed on a conduit end, the conduit fitting comprising a fitting body defining a central bore receiving the conduit end, a transducer is provided secured to a wall portion of the conduit end. The transducer is operated to apply a plurality of ultrasonic signals against an outer surface of the conduit end wall portion at a plurality of axial locations spaced apart from the central bore by a plurality of different distances, such that the plurality of ultrasonic signals are guided axially along the conduit end into the central bore of the conduit fitting and reflected axially back to the transducer. The reflected plurality of ultrasonic signals are evaluated to identify a condition of at least one of the conduit fitting and the conduit end.

### CROSS-REFERENCE TO RELATED APPLICATION

This application claims priority to U.S. Provisional Application Ser. No. 63/621,619 filed on Jan. 17, 2024, entitled DEVICES AND METHODS FOR INSPECTION OF CONDUIT FITTING ASSEMBLIES, the entire disclosure of which is fully incorporated by reference herein.

### TECHNICAL FIELD

The invention relates generally to apparatus and methods for non-destructive evaluation of fitting assemblies after assembly is completed. More particularly, the invention relates to using mechanical energy to make evaluations of the fitting assembly.

### BACKGROUND

Fluid handling equipment, whether the fluid is gas, liquid, combination of gas and liquid, slurries and so on, may use many fluid control devices that are connected together with the use of fittings. Typical fluid control devices include valves, regulators, meters and so on that are interconnected in a fluid circuit with a conduit, such as, for example, a tube or pipe. The fittings may take on a wide variety of designs, including but not limited to single ferrule and multi-ferrule tube fittings, various clamping arrangements using elastomeric seals, gripping rings and so on. For purposes of this disclosure we refer to tube and pipe as “conduit” because the present invention may be used with either tube or pipe.

Common to nearly all fluid circuits that use fittings to connect conduit to a flow control device or process is the desire to verify in a non-destructive manner that a fitting has been fully assembled. Most connections via fittings involve the positioning of a conduit within a fitting body or other structure associated with a fluid coupling (referred to herein as a fitting assembly of a conduit and coupling) such that an end of the conduit abuts a shoulder or wall of the fitting body or other structure. This abutment or “bottoming” as we also refer to it herein, is usually desirable as it allows that gripping device, such as a ferrule, to be installed onto the conduit without the conduit moving axially.

Inherent in the assembly process, however, is the practical circumstance that it is difficult to determine whether the conduit is properly installed in the fitting, including, for example, that the conduit is fully bottomed.

### SUMMARY

In accordance with an aspect of the present disclosure, in a method of inspecting a conduit fitting installed on a conduit end, the conduit fitting comprising a fitting body defining a central bore receiving the conduit end, a transducer is provided secured to the conduit end. The transducer is operated to apply a plurality of ultrasonic signals against an outer surface of the conduit end at a plurality of axial locations spaced apart from the central bore by a plurality of different distances, such that the plurality of ultrasonic signals are guided axially along the conduit end into the central bore of the conduit fitting and reflected axially back to the transducer. The reflected plurality of ultrasonic signals are evaluated to identify a condition of at least one of the conduit fitting and the conduit end.

In some implementations, operating the transducer to apply the plurality of ultrasonic signals comprises directing the plurality of ultrasonic signals in a direction perpendicular to the outer surface.

In some implementations, operating the transducer to apply the plurality of ultrasonic signals comprises applying the plurality of ultrasonic signals at a frequency of less than 10 MHz, or between about 0.5 MHz and about 7.5 MHz, or between about 2.2 MHz and about 5 MHz, or about 3.3 MHz, or about 4.5 MHz.

In some implementations, the transducer comprises a first set of axially spaced transducer elements operable to apply ultrasonic signals against the outer surface of the conduit end wall portion at the plurality of axial locations.

In some implementations, the first set of axially spaced transducer elements are operable to receive the reflected plurality of ultrasonic signals.

In some implementations, the transducer comprises a flexible printed circuit board (PCB) carrying the first set of axially spaced transducer elements.

In some implementations, the transducer comprises a first set of transducer elements and a second set of transducer elements.

In some implementations, the first set of transducer elements is operable to apply ultrasonic signals against the outer surface of the conduit end wall portion at the plurality of axial locations, and the second set of transducer elements is operable to receive the reflected plurality of ultrasonic signals.

In some implementations, the second set of transducer elements is circumferentially spaced apart from the first set of transducer elements.

In some implementations, the transducer comprises a flexible printed circuit board (PCB) carrying the first set of transducer elements.

In some implementations, the flexible PCB carries the second set of transducer elements.

In some implementations, the flexible PCB is a first flexible PCB, wherein the transducer further comprises a second flexible PCB carrying the second set of transducer elements.

In some implementations, evaluating the reflected plurality of ultrasonic signals comprises processing the reflected plurality of ultrasonic signals and transmitting the processed signals to a remote computer device.

In some implementations, the condition of the at least one of the conduit fitting and the conduit end comprises at least one of: conduit diameter, conduit wall thickness, conduit material, conduit material discontinuities, a fully bottomed condition of the installed conduit end, a partially bottomed condition of the installed conduit end, an un-bottomed condition of the installed conduit end, a location of an unbottomed portion relative to the body or ferrule position, a ferrule/conduit gripping member bite (or absence of a bite) consistent with proper pull-up, a ferrule/conduit gripping member bite (or absence of a bite) consistent with insufficient pull-up, a ferrule/conduit gripping member bite consistent with overtightening, a ferrule/conduit gripping member bite consistent with improper ferrule installation (e.g., incorrect orientation, incorrect quantity, and/or incorrect size or material of ferrule components), proper transducer element engagement with the conduit, and improper transducer element engagement with the conduit.

In some implementations, the transducer is secured to a conduit engaging portion of a tool, wherein providing the transducer secured to the wall portion of the conduit end comprises installing the tool on the conduit end.

In some implementations, the tool includes a clamping portion defining the conduit engaging portion, wherein installing the tool on the conduit end comprises clamping the tool onto the conduit end.

In some implementations, the conduit engaging portion comprises a contoured surface shaped for mating engagement with the outer surface of the conduit end wall portion.

In some implementations, the transducer comprises a flexible printed circuit board (PCB) secured to the conduit engaging portion.

In some implementations, the flexible PCB is movable with respect to the conduit engaging portion for conforming contact with the outer surface of the conduit end wall portion.

In some implementations, evaluating the reflected plurality of ultrasonic signals to identify the condition of the least one of the conduit fitting and the conduit end comprises generating a graphical representation of the reflected plurality of ultrasonic signals to identify signal strength and distance traveled of the reflected plurality of ultrasonic signals.

In some implementations, evaluating the reflected plurality of ultrasonic signals to identify the condition of the least one of the conduit fitting and the conduit end comprises comparing the generated graphical representation to a plurality of stored graphical representations corresponding to a plurality of possible conditions of the least one of the conduit fitting and the conduit end.

In some implementations, the generated graphical representation includes a portion corresponding to at least one of: a location of an end face of the conduit end, a degree of bottoming of the conduit end, a location of a ferrule bite on the conduit end, and a degree of ferrule bite on the conduit end.

In accordance with another aspect of the present disclosure, in a method of inspecting a conduit fitting installed on a conduit end, the conduit fitting comprising a fitting body defining a central bore receiving the conduit end, a transducer is provided secured to a wall portion of the conduit end. This transducer is operated to apply at least one radial ultrasonic signal against an outer surface of the conduit end wall portion, such that the at least one radial ultrasonic signal is guided radially through an annular wall of the conduit end and reflected radially back to the transducer, and the reflected at least one radial ultrasonic signal is detected. At least one axial ultrasonic signal is applied against the outer surface of the conduit end wall portion, such that the at least one axial ultrasonic signal is guided axially along the conduit end into the central bore of the conduit fitting and reflected axially back to the transducer, and the reflected at least one axial ultrasonic signal is detected. The reflected at least one radial ultrasonic signal is evaluated to determine a wall thickness of the conduit end, and the reflected at least one axial ultrasonic signal is evaluated to identify a condition of at least one of the conduit fitting and the conduit end, wherein the identified condition of the at least one of the conduit fitting and the conduit end is at least partially based on the determined nominal wall thickness.

In some implementations, operating the transducer to apply the at least one radial ultrasonic signal comprises directing the at least one radial ultrasonic signal in a direction perpendicular to the outer surface.

In some implementations, operating the transducer to apply the at least one radial ultrasonic signal comprises applying the at least one radial ultrasonic signal at a frequency of greater than about 10 MHz, or greater than about 20 MHz.

In some implementations, operating the transducer to apply the at least one axial ultrasonic signal comprises directing the at least one axial ultrasonic signal in a direction perpendicular to the outer surface.

In some implementations, operating the transducer to apply the at least one axial ultrasonic signal comprises applying the at least one axial ultrasonic signal at a frequency of less than 10 MHz, or between about 0.5 MHz and about 7.5 MHz, or between about 2.2 MHz and about 5 MHz, or about 3.3 MHz, or about 4.5 MHz.

In some implementations, the at least one radial ultrasonic signal comprises a plurality of radial ultrasonic signals applied at a plurality of spaced apart locations.

In some implementations, the at least one axial ultrasonic signal comprises a plurality of axial ultrasonic signals applied at a plurality of axial locations spaced apart from the central bore by a plurality of different distances.

In some implementations, the transducer comprises a first set of transducer elements operable to apply the at least one radial ultrasonic signal.

In some implementations, the first set of transducer elements is operable to receive the at least one reflected radial ultrasonic signal.

In some implementations, the first set of transducer elements is operable to apply the at least one axial ultrasonic signal.

In some implementations, the first set of transducer elements is operable to receive the at least one reflected axial ultrasonic signal.

In some implementations, the transducer comprises a flexible printed circuit board (PCB) carrying the first set of transducer elements.

In some implementations, the transducer comprises a first set of transducer elements and a second set of transducer elements.

In some implementations, the first set of transducer elements is operable to apply the at least one radial ultrasonic signal and to apply the at least one axial ultrasonic signal, and the second set of transducer elements is operable to receive the at least one reflected radial ultrasonic signal and to receive the at least one reflected axial ultrasonic signal.

In some implementations, the first set of transducer elements is operable to apply the at least one radial ultrasonic signal and to receive the at least one reflected radial ultrasonic signal, and the second set of transducer elements is operable to apply the at least one axial ultrasonic signal and to receive the at least one reflected axial ultrasonic signal.

In some implementations, the second set of transducer elements is circumferentially spaced apart from the first set of transducer elements.

In some implementations, the transducer comprises a flexible printed circuit board (PCB) carrying the first set of transducer elements.

In some implementations, the flexible PCB carries the second set of transducer elements.

In some implementations, the flexible PCB is a first flexible PCB, wherein the transducer further comprises a second flexible PCB carrying the second set of transducer elements.

In some implementations, evaluating the reflected at least one radial ultrasonic signal comprises processing the at least one reflected radial ultrasonic signal and transmitting the processed signal to a remote computer device.

In some implementations, evaluating the reflected at least one axial ultrasonic signal comprises processing the reflected plurality of ultrasonic signals and transmitting the processed signals to a remote computer device.

In some implementations, the condition of the at least one of the conduit fitting and the conduit end comprises at least one of: conduit diameter, conduit wall thickness, conduit material, conduit material discontinuities, a fully bottomed condition of the installed conduit end, a partially bottomed condition of the installed conduit end, an un-bottomed condition of the installed conduit end, a location of an unbottomed portion relative to the body or ferrule position, a ferrule/conduit gripping member bite (or absence of a bite) consistent with proper pull-up, a ferrule/conduit gripping member bite (or absence of a bite) consistent with insufficient pull-up, a ferrule/conduit gripping member bite consistent with overtightening, a ferrule/conduit gripping member bite consistent with improper ferrule installation (e.g., incorrect orientation, incorrect quantity, and/or incorrect size or material of ferrule components), proper transducer element engagement with the conduit, and improper transducer element engagement with the conduit.

In some implementations, the transducer is secured to a conduit engaging portion of a tool, wherein providing the transducer secured to the wall portion of the conduit end comprises installing the tool on the conduit end.

In some implementations, the tool includes a clamping portion defining the conduit engaging portion, wherein installing the tool on the conduit end comprises clamping the tool onto the conduit end.

In some implementations, the conduit engaging portion comprises a contoured surface shaped for mating engagement with the outer surface of the conduit end wall portion.

In some implementations, the transducer comprises a flexible printed circuit board (PCB) secured to the conduit engaging portion.

In some implementations, the flexible PCB is movable with respect to the conduit engaging portion for conforming contact with the outer surface of the conduit end wall portion.

In some implementations, evaluating the reflected at least one axial ultrasonic signal to identify the condition of the least one of the conduit fitting and the conduit end comprises generating a graphical representation of the reflected at least one axial ultrasonic signal to identify signal strength and distance traveled of the reflected at least one axial ultrasonic signal.

In some implementations, evaluating the reflected at least one axial ultrasonic signal to identify the condition of the least one of the conduit fitting and the conduit end comprises comparing the generated graphical representation to a plurality of stored graphical representations corresponding to a plurality of possible conditions of the least one of the conduit fitting and the conduit end.

In some implementations, the generated graphical representation includes a portion corresponding to at least one of: a location of an end face of the conduit end, a degree of bottoming of the conduit end, a location of a ferrule bite on the conduit end, and a degree of ferrule bite on the conduit end.

In accordance with another aspect of the present disclosure, a system for inspecting a conduit fitting installed on a conduit end, the conduit fitting comprising a fitting body defining a central bore receiving the conduit end, includes a tool including a tool body carrying a transducer and configured to be assembled with at least one of the conduit fitting and the conduit end to secure the transducer to an outer surface of a wall portion of the conduit end. The transducer includes a plurality of axially spaced transducer elements configured to apply a plurality of ultrasonic signals against the outer surface of the conduit end wall portion at a plurality of axial locations spaced apart from the central bore by a plurality of different distances, such that the plurality of ultrasonic signals are guided axially along the conduit end wall portion into the central bore of the conduit fitting and reflected axially back to the transducer.

In some implementations, the plurality of axially spaced transducer elements are positioned to apply the plurality of ultrasonic signals in a direction perpendicular to the outer surface.

In some implementations, the plurality of axially spaced transducer elements are configured to apply the plurality of ultrasonic signals at a frequency of less than 10 MHz, or between about 0.5 MHz and about 7.5 MHz, or between about 2.2 MHz and about 5 MHz, or about 3.3 MHz, or about 4.5 MHz.

In some implementations, the plurality of axially spaced transducer elements are operable to receive the reflected plurality of ultrasonic signals.

In some implementations, the transducer comprises a flexible printed circuit board (PCB) carrying the plurality of axially spaced transducer elements.

In some implementations, the plurality of axially spaced transducer elements is a first set of transducer elements, the transducer further comprising a second set of transducer elements.

In some implementations, the second set of transducer elements is operable to receive the reflected plurality of ultrasonic signals.

In some implementations, the second set of transducer elements is circumferentially spaced apart from the first set of transducer elements.

In some implementations, the transducer comprises a flexible printed circuit board (PCB) carrying the first and second sets of transducer elements.

In some implementations, the transducer comprises a first flexible printed circuit board (PCB) carrying the first sets of transducer elements and a second flexible PCB carrying the second set of transducer elements.

In some implementations, the transducer is secured to a conduit engaging portion of the tool.

In some implementations, the tool includes a clamping portion defining the conduit engaging portion.

In some implementations, the conduit engaging portion comprises a contoured surface shaped for mating engagement with the outer surface of the conduit end wall portion.

In some implementations, the transducer comprises a flexible printed circuit board (PCB) secured to the conduit engaging portion.

In some implementations, the flexible PCB is movable with respect to the conduit engaging portion for conforming contact with the outer surface of the conduit end wall portion.

In some implementations, the transducer is secured to the conduit engaging portion of the tool by a compressible backing material for conforming contact with the outer surface of the conduit end wall portion.

In some implementations, the tool includes a detachable insert securable to the tool body and defining the conduit engaging portion.

In some implementations, the detachable insert is a first detachable insert and the conduit engaging portion is a first conduit engaging portion sized for engagement with a first conduit having a first diameter, the system further comprising a second detachable insert securable to the tool body and defining a second conduit engaging portion sized for engagement with a second conduit having a second diameter different from the first diameter.

In some implementations, the system includes a processor configured to evaluate the reflected plurality of ultrasonic signals to identify a condition of the least one of the conduit fitting and the conduit end.

In some implementations, the processor is configured to generate a graphical representation of the reflected plurality of ultrasonic signals to identify signal strength and distance traveled of the reflected plurality of ultrasonic signals.

In some implementations, the processor is configured to compare the generated graphical representation to a plurality of stored graphical representations corresponding to a plurality of possible conditions of the least one of the conduit fitting and the conduit end.

In some implementations, the generated graphical representation includes a portion corresponding to at least one of: a location of an end face of the conduit end, a degree of bottoming of the conduit end, a location of a ferrule bite on the conduit end, and a degree of ferrule bite on the conduit end.

In some implementations, the tool body includes an electronics package comprising one or more of: a drive signal generator, a filter circuit for noise reduction of the received reflected signals, an analog to digital (A/D) converter for converting the electrical signal from the transducer into a digitized signal, a memory storage device for storing the digitized signal, a processor to facilitate interpretation of the data corresponding to one or more conditions of the conduit fitting assembly, a user interface for communicating the determined one or more conditions of the conduit fitting assembly, and a wireless transceiver for wirelessly transmitting ultrasonic sensor test data to a remote computer device.

In some implementations, the tool body encloses a battery unit electrically connected to the transducer.

In some implementations, the system includes an external hardware unit electrically connectable with the tool, the external hardware unit comprising one or more of: a drive signal generator, a filter circuit for noise reduction of the received reflected signals, an analog to digital (A/D) converter for converting the electrical signal from the transducer into a digitized signal, a memory storage device for storing the digitized signal, a processor to facilitate interpretation of the data corresponding to one or more conditions of the conduit fitting assembly, a user interface for communicating the determined one or more conditions of the conduit fitting assembly, and a wireless transceiver for wirelessly transmitting ultrasonic sensor test data to a remote computer device.

In some implementations, the external hardware unit includes a battery unit.

In accordance with another aspect of the present disclosure, a system for inspecting a conduit fitting installed on a conduit end, the conduit fitting comprising a fitting body defining a central bore receiving the conduit end, includes a tool including a tool body carrying a transducer and configured to be assembled with at least one of the conduit fitting and the conduit end to secure the transducer to an outer surface of a wall portion of the conduit end. The transducer includes at least one transducer element configured to apply at least one radial ultrasonic signal against the outer surface of the conduit end wall portion, such that the at least one radial ultrasonic signal is guided radially through an annular wall of the conduit end and reflected radially back to the transducer, and to apply at least one axial ultrasonic signal against the outer surface of the conduit end wall portion, such that the at least one axial ultrasonic signal is guided axially along the conduit end wall portion into the central bore of the conduit fitting and reflected axially back to the transducer.

In some implementations, the at least one transducer element is positioned to apply the at least one radial ultrasonic signal in a direction perpendicular to the outer surface.

In some implementations, the at least one radial transducer element is configured to apply the at least one radial ultrasonic signal at a frequency of greater than about 10 MHz, or greater than about 20 MHz.

In some implementations, the at least one transducer element is configured to apply the at least one axial ultrasonic signal at a frequency of less than 10 MHz, or between about 0.5 MHz and about 7.5 MHz, or between about 2.2 MHz and about 5 MHz, or about 3.3 MHz, or about 4.5 MHz.

In some implementations, the at least one transducer element is operable to receive the reflected at least one radial ultrasonic signal and the reflected at least one axial ultrasonic signal.

In some implementations, the at least one transducer element is configured to apply a plurality of radial ultrasonic signals at a plurality of spaced apart locations.

In some implementations, the at least one transducer element is configured to apply a plurality of axial ultrasonic signals applied at a plurality of axial locations spaced apart from the central bore by a plurality of different distances.

In some implementations, the at least one transducer element comprises a first set of transducer elements operable to apply the at least one radial ultrasonic signal.

In some implementations, the first set of transducer elements is operable to receive the at least one reflected radial ultrasonic signal.

In some implementations, the first set of transducer elements is operable to apply the at least one axial ultrasonic signal.

In some implementations, the first set of transducer elements is operable to receive the at least one axial ultrasonic signal.

In some implementations, the transducer comprises a flexible printed circuit board (PCB) carrying the first set of transducer elements.

In some implementations, the transducer comprises a first set of transducer elements and a second set of transducer elements.

In some implementations, the first set of transducer elements is operable to apply the at least one radial ultrasonic signal and to apply the at least one axial ultrasonic signal, and the second set of transducer elements is operable to receive the at least one reflected radial ultrasonic signal and to receive the at least one reflected axial ultrasonic signal.

In some implementations, the first set of transducer elements is operable to apply the at least one radial ultrasonic signal and to receive the at least one reflected radial ultrasonic signal, and the second set of transducer elements is operable to apply the at least one axial ultrasonic signal and to receive the at least one reflected axial ultrasonic signal.

In some implementations, the second set of transducer elements is circumferentially spaced apart from the first set of transducer elements.

In some implementations, the transducer comprises a flexible printed circuit board (PCB) carrying the first set of transducer elements.

In some implementations, the flexible PCB carries the second set of transducer elements.

In some implementations, the flexible PCB is a first flexible PCB, wherein the transducer further comprises a second flexible PCB carrying the second set of transducer elements.

In some implementations, the transducer is secured to a conduit engaging portion of the tool.

In some implementations, the tool includes a clamping portion defining the conduit engaging portion.

In some implementations, the conduit engaging portion comprises a contoured surface shaped for mating engagement with the outer surface of the conduit end wall portion.

In some implementations, the transducer comprises a flexible printed circuit board (PCB) secured to the conduit engaging portion.

In some implementations, the flexible PCB is movable with respect to the conduit engaging portion for conforming contact with the outer surface of the conduit end wall portion.

In some implementations, the transducer is secured to the conduit engaging portion of the tool by a compressible backing material for conforming contact with the outer surface of the conduit end wall portion.

In some implementations, the tool includes a detachable insert securable to the tool body and defining the conduit engaging portion.

In some implementations, the detachable insert is a first detachable insert and the conduit engaging portion is a first conduit engaging portion sized for engagement with a first conduit having a first diameter, the system further comprising a second detachable insert securable to the tool body and defining a second conduit engaging portion sized for engagement with a second conduit having a second diameter different from the first diameter.

In some implementations, the system includes a processor configured to evaluate the reflected at least one axial ultrasonic signal to identify a condition of the least one of the conduit fitting and the conduit end.

In some implementations, the processor is configured to generate a graphical representation of the reflected at least one axial ultrasonic signal to identify signal strength and distance traveled of the reflected at least one axial ultrasonic signal.

In some implementations, the processor is configured to compare the generated graphical representation to a plurality of stored graphical representations corresponding to a plurality of possible conditions of the least one of the conduit fitting and the conduit end.

In some implementations, the generated graphical representation includes a portion corresponding to at least one of: a location of an end face of the conduit end, a degree of bottoming of the conduit end, a location of a ferrule bite on the conduit end, and a degree of ferrule bite on the conduit end.

In some implementations, the tool body includes an electronics package comprising one or more of: a drive signal generator, a filter circuit for noise reduction of the received reflected signals, an analog to digital (A/D) converter for converting the electrical signal from the transducer into a digitized signal, a memory storage device for storing the digitized signal, a processor to facilitate interpretation of the data corresponding to one or more conditions of the conduit fitting assembly, a user interface for communicating the determined one or more conditions of the conduit fitting assembly, and a wireless transceiver for wirelessly transmitting ultrasonic sensor test data to a remote computer device.

In some implementations, the tool body encloses a battery unit electrically connected to the transducer.

In some implementations, the system includes an external hardware unit electrically connectable with the tool, the external hardware unit comprising one or more of: a drive signal generator, a filter circuit for noise reduction of the received reflected signals, an analog to digital (A/D) converter for converting the electrical signal from the transducer into a digitized signal, a memory storage device for storing the digitized signal, a processor to facilitate interpretation of the data corresponding to one or more conditions of the conduit fitting assembly, a user interface for communicating the determined one or more conditions of the conduit fitting assembly, and a wireless transceiver for wirelessly transmitting ultrasonic sensor test data to a remote computer device.

In some implementations, the external hardware unit includes a battery unit.

In accordance with another aspect of the present disclosure, an ultrasonic device for inspecting a conduit fitting installed on a conduit end, the conduit fitting comprising a fitting body defining a central bore receiving the conduit end, a conduit gripping device at least partially received in the central bore, and a fitting nut threadably assembled with the fitting body for tightening the conduit gripping device against the conduit end, includes a tool including a tool body carrying a transducer and configured to be assembled with at least one of the conduit fitting and the conduit end to secure the transducer to an outer surface of the conduit end, and a gauge arm extending axially from the tool body, the gauge arm being configured to extend axially over the fitting nut to contact a radially extending surface of the fitting body for axial positioning of the transducer with respect to the central bore. The transducer includes at least a first electrode configured to apply at least one axial ultrasonic signal against the outer surface of the conduit end, such that the at least one axial ultrasonic signal is guided axially along the conduit end into the central bore of the conduit fitting and reflected axially back to the transducer.

### BRIEF DESCRIPTION OF THE DRAWINGS

Further advantages and benefits will become apparent to those skilled in the art after considering the following description and appended claims in conjunction with the accompanying drawings, in which:

FIG. 1 is a partial cross-sectional view of a conventional conduit fitting;

FIG. 2 is a schematic side view of a conduit fitting assembly with a shear wave generating inspection tool applied thereto;

FIG. 3 is a schematic cross-sectional side view of a shear wave generating inspection tool applied to a conduit;

FIG. 4 is a schematic cross-sectional side view of a guided wave generating inspection tool applied to a conduit fitting assembly, in accordance with one or more exemplary aspects of the present disclosure;

FIG. 5 is a schematic cross-sectional side view of another guided wave generating inspection tool applied to a conduit fitting assembly, in accordance with one or more exemplary aspects of the present disclosure;

FIG. 5A is a schematic cross-sectional side view of an array of axially spaced transducer electrodes on a conduit, imparting a guided wave in accordance with one or more exemplary aspects of the present disclosure;

FIG. 5B is a schematic cross-sectional side view of another array of axially spaced transducer electrodes on a conduit, imparting a guided wave in accordance with one or more exemplary aspects of the present disclosure;

FIGS. 6 and 7 are top and side views of an exemplary flexible transducer;

FIG. 8A is a top view of an exemplary electrode array for a transducer, in accordance with one or more exemplary aspects of the present disclosure;

FIG. 8B is a top view of another exemplary electrode array for a transducer, in accordance with one or more exemplary aspects of the present disclosure;

FIG. 8C is a top view of another exemplary electrode array for a transducer, in accordance with one or more exemplary aspects of the present disclosure;

FIG. 8D is a top view of another exemplary electrode array for a transducer, in accordance with one or more exemplary aspects of the present disclosure;

FIG. 9 is a schematic end view of an exemplary clamping inspection tool installed on a conduit, in accordance with one or more exemplary aspects of the present disclosure;

FIGS. 10A through 21 illustrate a variety of clamping arrangements for a clamping inspection tool, in accordance with one or more exemplary aspects of the present disclosure;

FIGS. 22 through 24 illustrate various views of an exemplary clamping inspection tool, in accordance with one or more exemplary aspects of the present disclosure;

FIGS. 25A, 25B, and 25C are perspective views of clamping inspection tools adapted for use with different size conduits, in accordance with one or more exemplary aspects of the present disclosure;

FIGS. 26A, 26B, and 26C are views of an exemplary inspection tool, in accordance with one or more exemplary aspects of the present disclosure;

FIGS. 27A, 27B, 27C, and 27D are views of an exemplary inspection tool, in accordance with one or more exemplary aspects of the present disclosure;

FIG. 28 is a schematic side cross-sectional view of an inspection tool installed on a conduit fitting assembly, in accordance with one or more exemplary aspects of the present disclosure; and

FIG. 29 is a perspective view of a transducer bearing member for use with an inspection tool, in accordance with one or more exemplary aspects of the present disclosure.

### DESCRIPTION

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present disclosure may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims, as currently written or as amended or added in the future. Descriptions of exemplary methods or processes are not limited to inclusion of all steps as being required in all cases, nor is the order that the steps are presented to be construed as required or necessary unless expressly so stated.

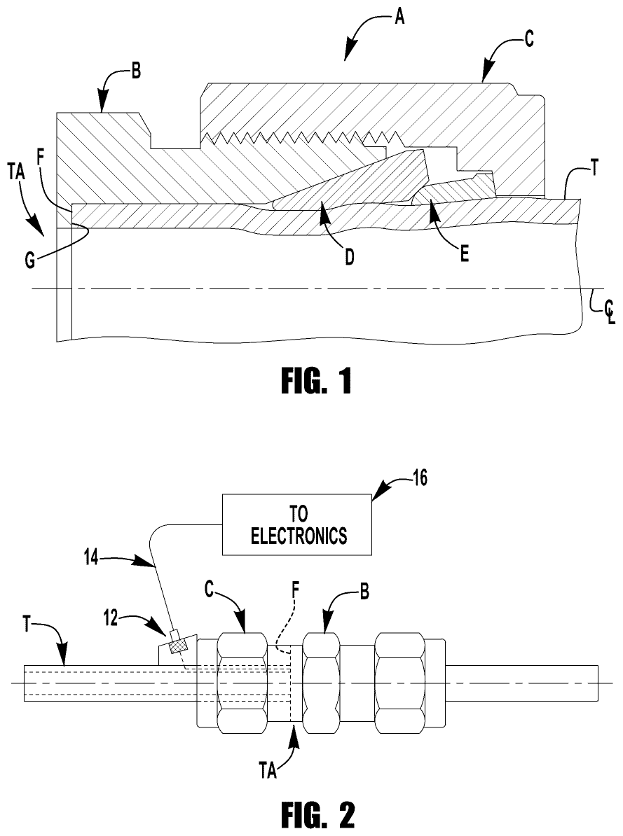

With reference to FIG. 1, there is illustrated a highly successful two ferrule tube fitting A. This fitting A is described in U.S. Pat. No. 3,103,373, the entire disclosure of which is incorporated herein by reference. The illustration of FIG. 1 shows only one half of the fitting, it being recognized by those skilled in the art that the other half of the view is identical about the centerline CL.

The fitting A includes a body B, a nut C that is threadably engaged with the body B during finger-tight assembly and pull-up, a front ferrule D and a back ferrule E. The fitting A is illustrated installed on a conduit, in this case in the form of a tube end T. The tubing T may carry a media such as liquid, gas, slurry and so on. The assembly in FIG. 1 is illustrated in the pulled-up condition, with the ferrules D and E plastically deformed so as to provide a fluid tight seal and strong grip on the tube end T.

In some applications, is desirable that the inner end F of the tube end T abut at the region TA defined at a radial shoulder G formed in the body B. This abutment is referred to as “bottoming” the tube end T and is desirable to provide a strong mechanical assemblage, including forming a good seal and having a strong tube grip, that can withstand environmental conditions such as temperature variations and vibration effects. A seal may but need not be formed at the abutment between the surfaces F and G. Whether a seal is formed there or not, it would be advantageous to be able to determine that the tube end is bottomed and the quality, nature or completeness of the contact. A tube end could be partially or incompletely bottomed by virtue of the assembler failing to properly insert the tube end sufficiently into the body B in accordance with the manufacturer's instructions.

A fully bottomed conduit end would be a condition in which there was substantial surface to surface contact between the conduit end and the body shoulder and good solid mechanical contact or compression therebetween. A partially bottomed conduit end would be a condition in which, for example, there is not substantial surface to surface contact due to poor end facing of the conduit end, a cocked or tilted conduit, an outer edge (OD) of the conduit end face making contact with a chamfer or fillet in the fitting body (e.g., between the tube bore and the body shoulder), or from contact between the tube end face and a fitting body shoulder that is not flat and/or perpendicular to the tube bore, or simply a lack of strong compression between the two abutting surfaces. A conduit end that is not bottomed would be a condition of little or no surface to surface contact or the presence of an actual axial gap between the non-abutting surfaces. Therefore, as used herein, the nature or quality of the contact between the conduit end and the abutting surface refers generally but not exclusively to various features either alone or in various combinations including the amount of surface area where contact is made, the force or load between the conduit end and the abutting surface, presence of a gap therebetween, lack of square alignment of the abutting surfaces, and so on.

Although the invention is described herein with particular reference to its use with a two ferrule flareless tube fitting, such as the fitting described above and shown in FIG. 1, those skilled in the art will readily appreciate that the invention may be used in many other applications, and generally to any application wherein it is desired to determine the relative and/or absolute axial position of an end of a conduit, such as tubing or pipe, whether the conduit end is positioned with a fluid coupling, a fluid flow device or so on. In many coupling applications, simply knowing the quality of the conduit end insertion, for example whether the conduit end is fully bottomed, partially bottomed or not bottomed, is the most useful information, regardless of the ability to detect axial position of the conduit end.

The present disclosure contemplates apparatus and methods relating to determining assembly conditions of a fluid coupling installed on a conduit. This determination may include, for example, one or more of determining the axial position of an end of the conduit within a fluid coupling, determining the existence and/or quality of contact between the conduit and a surface associated with the fluid coupling, and determining the location and/or quality of conduit grip by the coupling.

With destructive testing/inspection of a conduit fitting assembly being impracticable, and X-ray inspection of a conduit fitting assembly being cost prohibitive and requiring skilled operators, ultrasonic testing and inspection of conduit fitting assemblies has been contemplated, with systems and methods being described in U.S. Pat. No. 7,581,445 (the “'445 patent”), the entire disclosure of which is incorporated herein by reference.

FIG. 2 illustrates an exemplary embodiment described and shown in the '445 patent, in which an input energy source or input device 12 is coupled to the conduit T so as to apply mechanical input energy into the conduit T, wherein a portion of the applied input energy is reflected back or returned. The source device 12 may be, for example, a transducer that converts an electrical drive signal into vibration or mechanical energy. One example is an ultrasonic transducer that emits a high frequency signal which may be reflected or otherwise returned to the source 12 by a variety of conditions including but not limited to inclusions, micro-structural deformations, voids, the tube end F, and tubing deformations or indentations such as the ferrule bite or compression. The source 12 is used as a transmitter as well as a receiver or sensor and converts the reflected energy that reaches the source 12 into a corresponding electrical signal. Alternatively, the transmitter and receiver may be separate or different devices. The source 12 is coupled via a cable 14 or other suitable connection to an electronics arrangement 16. The electronics 16 includes appropriate circuitry that generates the drive signal for the source device 12 and that receives the electrical signals from the source device 12.

The '455 patent describes the source device 12 as a shear wave ultrasonic transducer that is driven by an electronics arrangement 16, via cable 14, to apply an input energy to the conduit T in the form of a shear wave applied into the conduit generally longitudinally or along the axial direction of the conduit surface. This longitudinally applied shear wave produces a return reflection or echo from the end of the conduit for detection or reception by the source device 12 and communication to the electronics arrangement 16 via cable 14 or other suitable connection.

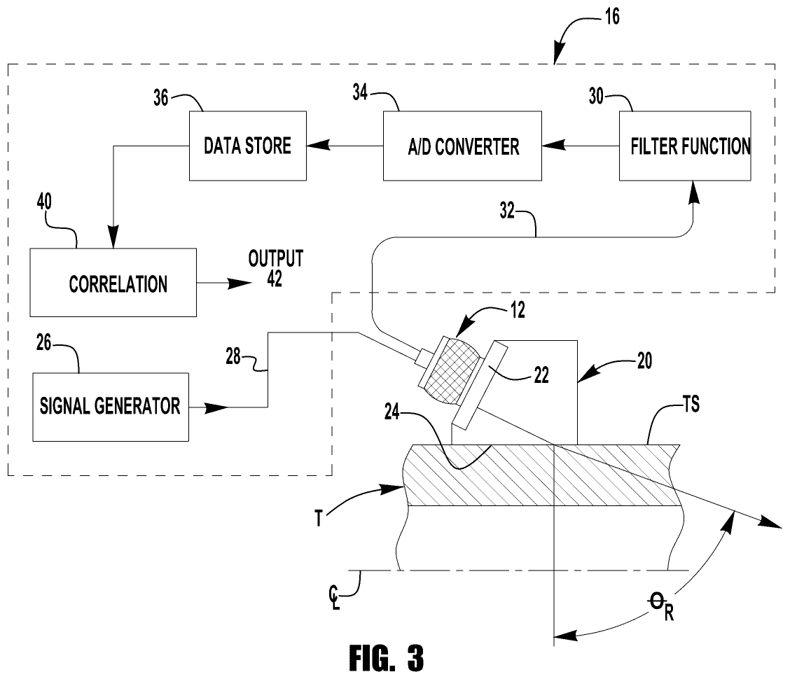

As shown in FIG. 3, the electronics arrangements 16 includes a signal generator 26 that produces a suitable drive signal for delivery to the transducer 12 via a suitable cable or wire 28, such that the transducer, having an ultrasonic signal emitting face 22 angled away from normal towards the conduit longitudinal axis CL, transmits an ultrasonic signal through a surface 24 of the base 20 and into the conduit T, for generation of the shear wave.

As further shown, the analyzer processor 16 further includes a filter function 30 that may be used for noise reduction of the reflected signal received from the transducer 12 (through connection 32), an analog to digital (A/D) converter 34 for converting the electrical signal from the transducer 12 into a digitized signal that can be conveniently stored in a storage device such as a memory 36, and a correlation function 40 to facilitate interpretation of the data corresponding to the condition of the conduit fitting assembly, and generation of a user discernible output 42.

The angled orientation of the transducer on the conduit surface, used to facilitate the shear wave propagation along the conduit, requires a transducer supporting base having a thickness sufficient to provide the desired angular offset. This intermediary material may, in some applications, impair coupling and signal delivery of the transducer to the conduit surface, and may limit the amount of ultrasonic energy that may be imparted on the conduit by the transducer(s).

According to an exemplary aspect of the present disclosure, a system for inspecting a conduit fitting assembly may utilize a guided wave transducer, instead of a shear wave transducer, for directing an axial ultrasonic wave or signal into the conduit such that a pressure wave propagates through the outer and inner diameter surfaces of the conduit and along the length of the conduit, as compared to a shear wave, which reflects off of the inner and outer surfaces of the conduit wall at angles of incidence corresponding to the angle of the transducer face. This type of guided wave is also referred to as a Lamb wave, constrained by the elastic properties of the article surface, with the wave velocity depending on the relationship between wavelength, article thickness, material density, and material elasticity.

Unlike the shear wave transducer, which is angled with respect to the conduit surface to direct and incidentally reflect the shear wave along the length of the conduit, the guided wave transducer may be positioned (e.g., with ultrasonic sensor emitting face parallel to and/or in contact with the outer surface of the conduit) to direct or impart the ultrasonic wave or signals in a direction perpendicular to or normal to the conduit surface. In such an orientation, lower frequency ultrasonic waves or signals (e.g., less than 10 MHz, or between about 0.5 MHz and about 7.5 MHz, or between about 2.2 MHz and about 5 MHz, or about 3.3 MHz, or about 4.5 MHz) have been found to be effective in generating a guided wave in a relatively thin walled article, such as, for example, a conduit having a wall thickness up to about 5 mm, or up to about 10 mm. In some applications, a relatively lower frequency ultrasonic wave may facilitate the generation of a distinguishable waveform corresponding to one or more conditions of the conduit fitting assembly.

Additionally or alternatively, perpendicularly applied higher frequency ultrasonic waves (e.g., greater than about 10 MHz, or greater than about 20 MHz) may provide focused longitudinal waves, or radial ultrasonic signals, across the thickness of the conduit, generating feedback or reflected radial ultrasonic signals that provide an indication of conduit wall thickness, as also contemplated herein. In some applications, a separate electrode may be dedicated to providing a radial ultrasonic signal across the thickness of the conduit wall for measurement of wall thickness and/or conduit diameter (for example, by applying radial ultrasonic signals at multiple positions around the circumference of the conduit). In other applications, an electrode may be configured to perform both wall thickness testing (e.g., using higher frequency radial ultrasonic signals) and guided wave inspection testing (e.g., using lower frequency axial ultrasonic signals) as separate steps, and may impart different ultrasonic signals (e.g., different frequencies) for the two tests. In such an arrangement, an initial radial ultrasonic signal test to identify wall thickness/conduit diameter may be performed to utilize a narrower conduit type specific data set for comparing with subsequent axial ultrasonic signal (guided wave) testing.

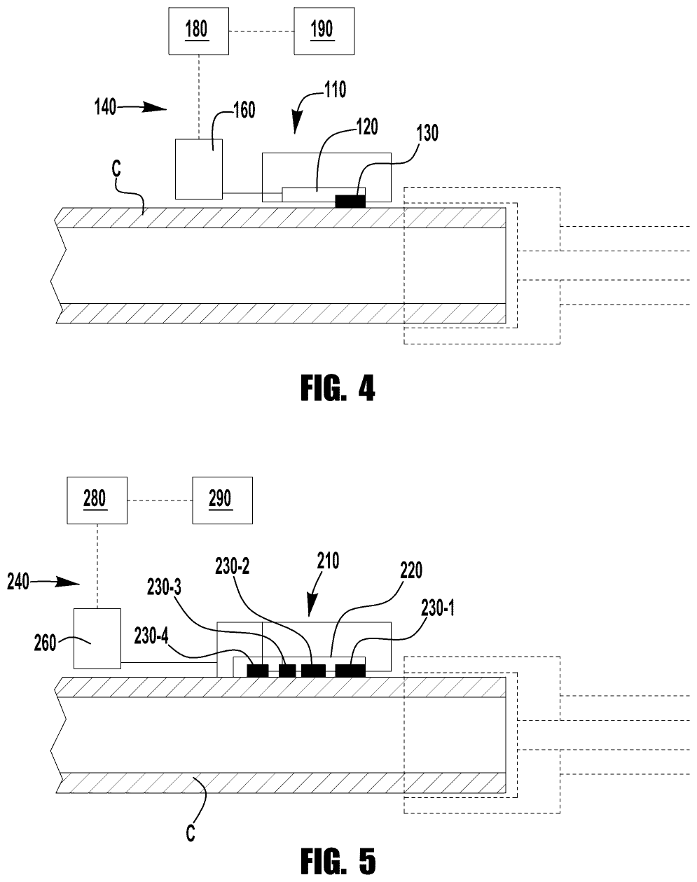

FIG. 4 schematically illustrates an inspection device or tool 110 coupled to a conduit C so as to apply an ultrasonic signal for generation of a guided wave. The inspection device 110 includes a transducer 120 connected with electronic elements 140 of the device and including an electrode 130 (e.g., piezoelectric element) that receives a drive signal from a signal generator provided with the electronic elements 140 of the device 110 to generate an ultrasonic signal to impart on the conduit T. The same electrode 130 may function as a receiver to receive the reflected guided wave and to convert the reflected wave energy into a corresponding electrical signal for transmission, through suitable electronic circuitry (e.g., traces and connectors) to a processor for conditioning and evaluating the reflected signal. The schematically illustrated electronic elements 140 may be provided as an electronics hardware module, apparatus, assembly, or system that includes both a signal generator and signal receiver and processor of the reflected signals of the guided wave transmitted and received by the electrode/sensor (e.g., piezoelectric element(s)). Such electronics hardware can provide signal conditioning and/or signal sequencing, for example, to produce a digital image/pattern or graphical representation of the reflected signal which can be interpreted by a processor of the of the electronic elements 140 or alternatively provided to another processor (e.g., of a remote or locally connected computer) and/or displayed for interpretation of the assembled fitting condition.

In some embodiments, the tool 110 may be a self-contained ultrasonic testing device, with an electronics package 160 including all of the electronics elements 140, including, for example, a drive signal generator, a filter circuit for noise reduction of the received reflected signals, an analog to digital (A/D) converter for converting the electrical signal from the transducer into a digitized signal, a memory storage device for storing the digitized signal, a processor to facilitate interpretation of the data corresponding to one or more conditions of the conduit fitting assembly, and a user interface for communicating (e.g., display/visual and/or speaker/audible) the determined one or more conditions of the conduit fitting assembly. In some arrangements, the tool electronics package may include a wireless transceiver for wirelessly transmitting ultrasonic sensor test data to a remote computer device for further processing and/or reporting, and/or for receiving wireless command signals from a remote computer device. In some arrangement, the tool may include an internal battery unit to power the electronics package, for example, to eliminate the need for external wiring and/or an external power source.

In other embodiments, the electronics package 160 may be connected to an external hardware unit (shown schematically at 180), for example, by suitable wiring, which may include, for example, a cable connection for ease of replacement of the clamp device. In an exemplary embodiment, the wiring/cable provides transmit signals (power signals) to the transducer from the external hardware unit 180 and transmits the reflected signals back to the hardware unit, both of which are sent and received by the external hardware unit. In some arrangements, the tool electronics package 160 includes a filter circuit for noise reduction of the received reflected signals, and the external hardware unit 180 includes a drive signal generator, an analog to digital (A/D) converter for converting the electrical signal from the transducer into a digitized signal, a memory storage device for storing the digitized signal, a processor to facilitate interpretation of the data corresponding to one or more conditions of the conduit fitting assembly and a user interface for communicating (e.g., display/visual and/or speaker/audible) the determined one or more conditions of the conduit fitting assembly. In some arrangement, the external hardware unit 680 may include an internal battery unit to power the hardware unit, for example, to eliminate the need for external wiring to an external power source.

The external hardware unit 180 may be connected with (e.g., wired or wireless communication with) a computing device 190 (e.g., computer, tablet, smart phone) for evaluation, communication, and/or display of information corresponding to the received signals. In some arrangements, a memory storage device, data interpreting processor, and/or user interface provided in the computing device 190 may eliminate the need for one or more of these components in the external hardware unit 180, for example, to simplify the electronics in the external hardware unit.

In the shear wave generating device described in the '445 patent, a single ultrasonic signal or pulse is generally sufficient to generate a shear wave that may be propagated axially along the length of the conduit into the conduit fitting and reflected back to the transducer at magnitudes and/or elapsed times (“time of flight”) that may be indicative of a condition of the conduit fitting assembly (e.g., an un-bottomed conduit end within the fitting). According to an exemplary aspect of the present disclosure, a device for imparting ultrasonic wave signals into a conduit may include a sensor device configured to generate multiple ultrasonic signals imparted against the conduit surface for generation of a guided wave of sufficient amplitude and frequency to allow a receive signal with suitable signal to noise ratio (e.g., at least 20 dB). In some embodiments, the applied signal imparts a sine wave, half sine wave, or equivalent excitation which may include one or more wave cycles. In an exemplary arrangement, a sensor device may be configured to generate a wave packet comprising a series of bipolar wave cycles (e.g., 3-12 cycles) per acquisition, although other numbers of wave cycles may be used within a single wave packet.

According to another exemplary aspect of the present disclosure, a device for imparting ultrasonic wave signals into a conduit may include a sensor device configured to generate, simultaneously and/or sequentially, multiple ultrasonic signals imparted against the conduit surface at a plurality of axially spaced locations, for generation of a guided wave of sufficient amplitude and frequency to allow a receive signal with suitable signal to noise ratio (e.g., at least 20 dB). In an exemplary arrangement, a sensor device may be provided with a transducer including an array (e.g., a linear array) of ultrasonic signal emitting elements (e.g., piezoelectric elements or other suitable electrodes) axially spaced apart on the conduit to apply ultrasonic signals or pulses at a plurality of axially spaced locations to generate a guided wave having a desired magnitude and velocity. In some arrangements, signal emitting electrodes may be selectively shaped, spaced and oriented (e.g., rectangular electrodes in a tightly spaced, parallel linear placement) to dictate the frequency and transmitted direction (e.g., higher frequency in the direction of the parallel linear electrode placement) of the guided waves. For example, the axial spacing of the electrodes may be selected to generate a desired resultant frequency of the generated guided waves.

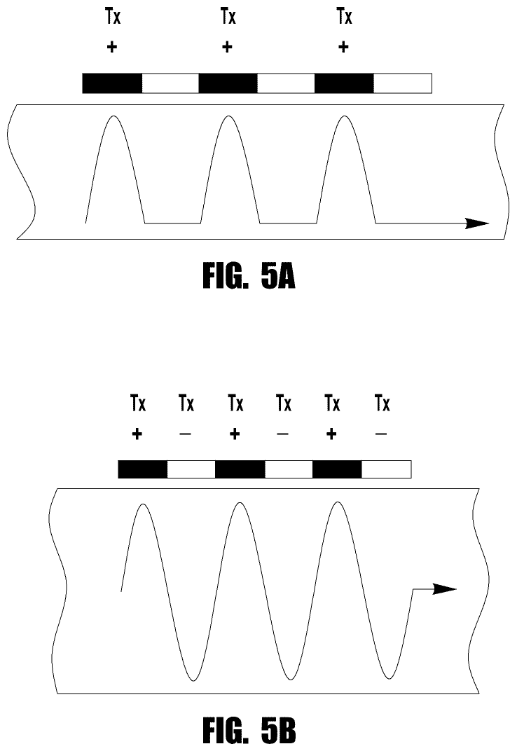

FIG. 5 schematically illustrates another inspection device 210 coupled to a conduit T so as to apply an ultrasonic signal for generation of a guided wave. The inspection device 210 includes a transducer 220 connected with electronic elements 240 of the device and including a series or array of electrodes 230-1, 230-2, 230-3, 230-4 (e.g., piezoelectric elements) that receives a drive signal from a signal generator provided with the electronic elements 240 of the device 210 to generate an ultrasonic signal to impart on the conduit T. The array of electrodes 230-1, 230-2, 230-3, 230-4 may function as a receiver to receive the reflected guided wave and to convert the reflected wave energy into a corresponding electrical signal for transmission, through suitable electronic circuitry (e.g., traces and connectors) to a processor for conditioning and evaluating the reflected signal. In some implementations, a first subset (one or more) of the plurality of electrodes may be dedicated to transmitting signals, and a separate second subset (one or more) of the plurality of electrodes may be dedicated to receiving signals. Such an arrangement may further simply the electronics required to transmit and receive signals. In other implementations, all of the electrodes in the array may function to both transmit ultrasonic signals and receive reflected signals.

In some embodiments, the tool 210 may be a self-contained ultrasonic testing device, with an electronics package 260 including all of the electronics elements 240, including, for example, a drive signal generator, a filter circuit for noise reduction of the received reflected signals, an analog to digital (A/D) converter for converting the electrical signal from the transducer into a digitized signal, a memory storage device for storing the digitized signal, a processor to facilitate interpretation of the data corresponding to one or more conditions of the conduit fitting assembly, and a user interface for communicating (e.g., display/visual and/or speaker/audible) the determined one or more conditions of the conduit fitting assembly. In some arrangements, the tool electronics package may include a wireless transceiver for wirelessly transmitting ultrasonic sensor test data to a remote computer device for further processing and/or reporting, and/or for receiving wireless command signals from a remote computer device. In some arrangement, the tool may include an internal battery unit to power the electronics package, for example, to eliminate the need for external wiring and/or an external power source.

In other embodiments, the electronics package 260 may be connected to an external hardware unit (shown schematically at 280), for example, by suitable wiring, which may include, for example, a cable connection for ease of replacement of the clamp device. In an exemplary embodiment, the wiring/cable provides transmit signals (power signals) to the transducer from the external hardware unit 280 and transmits the reflected signals back to the hardware unit, both of which are sent and received by the external hardware unit. In some arrangements, the tool electronics package 260 includes a filter circuit for noise reduction of the received reflected signals, and the external hardware unit 280 includes a drive signal generator, an analog to digital (A/D) converter for converting the electrical signal from the transducer into a digitized signal, a memory storage device for storing the digitized signal, a processor to facilitate interpretation of the data corresponding to one or more conditions of the conduit fitting assembly and a user interface for communicating (e.g., display/visual and/or speaker/audible) the determined one or more conditions of the conduit fitting assembly. In some arrangement, the external hardware unit 680 may include an internal battery unit to power the hardware unit, for example, to eliminate the need for external wiring to an external power source.

The external hardware unit 280 may be connected with (e.g., wired or wireless communication with) a computing device 290 (e.g., computer, tablet, smart phone) for evaluation, communication, and/or display of information corresponding to the received signals. In some arrangements, a memory storage device, data interpreting processor, and/or user interface provided in the computing device 290 may eliminate the need for one or more of these components in the external hardware unit 280, for example, to simplify the electronics in the external hardware unit.

In the schematically illustrated embodiment, the transducer 220 includes an array of four axially spaced electrodes 230-1, 230-2, 230-3, 230-4. In other implementations, the transducer may include a different number of electrodes (e.g., 2, 3, or more than 4). In some applications, the number of electrodes may be selected so as to be both cost efficient and sufficient to provide a more clearly defined response wave or reflected wave, without generating an overlapping signal, as may result from guided waves that are longer in duration and may generate overlapping reflections/echoes from structural features in close proximity.

In some implementations, all of the electrodes may be operated to transmit signals simultaneously, to impart simultaneous ultrasonic signals at multiple axial locations on the conduit. The electrodes may each simultaneously impart a series of multiple signals (e.g., at times t1, t2, . . . , tₙ) to generate the desired guided wave, which may produce a half sine wave, as shown in FIG. 5A.

In some implementations, the electrodes may be operated to transmit signals sequentially, to impart sequential ultrasonic signals at multiple axial locations on the conduit. The electrodes may each sequentially impart a series of multiple signals to generate the desired guided wave.

In some implementations, a first subset (two or more) of the electrodes may simultaneously impart ultrasonic signals at a first time t₁, and a separate second subset (two or more) of the electrodes may subsequently simultaneously impart ultrasonic signals at a second time t₂. In other implementations, a greater number of subsets (e.g., 3 or more) may be utilized for sequential emission of ultrasonic signals from multiple electrodes.

In some implementations, the electrodes may be configured to receive the responding or reflected signals before a subsequent signal in a sequence of signals is transmitted by each electrode.

In an exemplary implementation of the schematically illustrated embodiment, first and third electrodes 230-1, 230-3 simultaneously impart ultrasonic signals, and second and fourth electrodes 230-2, 230-4 simultaneously impart ultrasonic signals which may further be inverted (i.e., 180°) relative to the first and third electrodes, for example, to create a sine wave, as shown in FIG. 5B. In some implementations, the electrodes may each be independently or discretely wired or connected with the controlling electronics, which may be operable for simultaneous activation of a first subset of electrodes (e.g., first and third electrodes 230-1, 230-3), with simultaneous activation of a second subset of electrodes (e.g., second and fourth electrodes 230-2, 230-4) with an inverted signal. In other implementations, subsets of the electrodes may be arranged as connected electrodes, for example, within an interdigitated array, with a single channel for each subset to simultaneously drive the electrodes of the subset to generate an ultrasonic signal. In the exemplary embodiment of FIG. 5, the first and third electrodes 230-1, 230-3 may be electrically connected for simultaneous activation, and the second and fourth electrodes 230-2, 230-4 may be electrically connected for simultaneous activation with an inverted signal to provide for the desired alternating operation of the electrodes.

A variety of suitable transducer arrangements may be utilized to impart axially spaced ultrasonic signals to a conduit to generate a guided wave propagating along the length of the conduit, and to receive the reflected response wave for processing and analysis. In some embodiments, the transducer may be a flexible transducer configured to conform to the cylindrical contoured outer surface of the conduit. The use of a flexible (e.g., membrane-based flexible printed circuit board (PCB)) transducer may provide advantages, for example, in ease of sensor electrode placement and arrangement (particularly for greater numbers of electrodes), ability to couple with contoured surfaces (e.g., the outer surface of a conduit), Exemplary flexible transducers are shown and described in U.S. Patent App. Pub. No. 2020/0406299 (the “'299 Publication”), the entire disclosure of which is incorporated herein by reference.

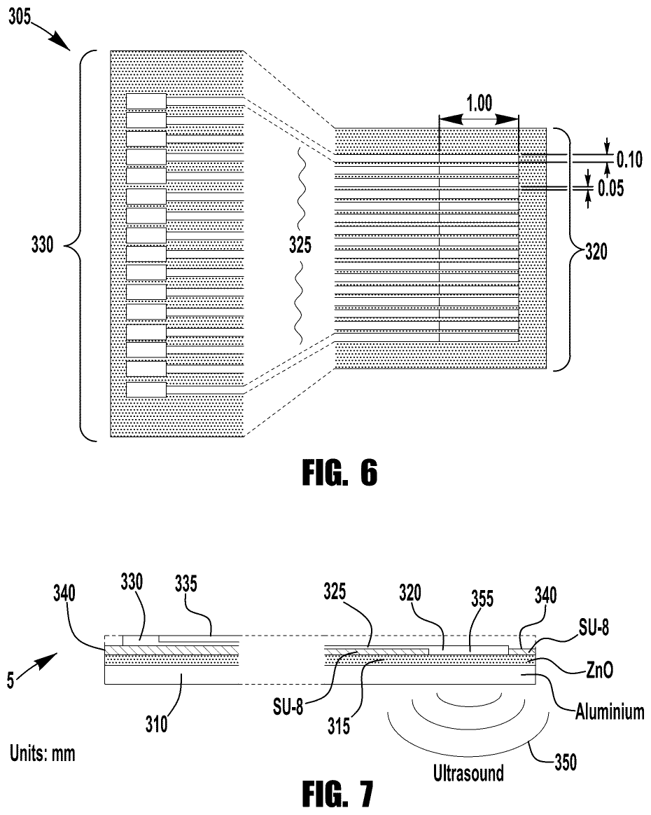

FIGS. 6 and 7 illustrate top and side views of an exemplary embodiment of a flexible transducer described and shown in the '299 Publication, in which the flexible transducer includes an ultrasonic transducer array 305 having an electrically conductive substrate 310 in the form of a metal foil, and a layer of crystalline piezoelectric material 315 disposed on one planar surface of the substrate 310, which acts to support the layer of piezoelectric material 315 and also functions as a counter electrode and ultrasonic wave radiation surface from which ultrasonic waves are emitted from the transducer array in use. An array of metallic elongate electrodes 320 are linearly distributed on a surface of the layer of piezoelectric material 315 opposite the substrate 310 with each electrode 320 connected to a corresponding electrically conductive track 325 which extends to an associated electrical connector 330, such that each electrode 320 in the array is individually operable/addressable by electrically driving/addressing the corresponding connector 330. Methods of manufacturing the transducer are described in the above incorporated '299 Publication.

In order to generate the ultrasonic wave, an alternating electrical driving current is applied to the appropriate connector(s) 330 and for transmission to the corresponding electrode(s) 320 via the corresponding conductive track(s) 325, which causes the corresponding section(s) of piezoelectric material to vibrate at high frequency along with the corresponding portion of the substrate to thereby generate ultrasonic waves, which are emitted from portions of the outer surface of the substrate that correspond to the driven electrode(s) 320.

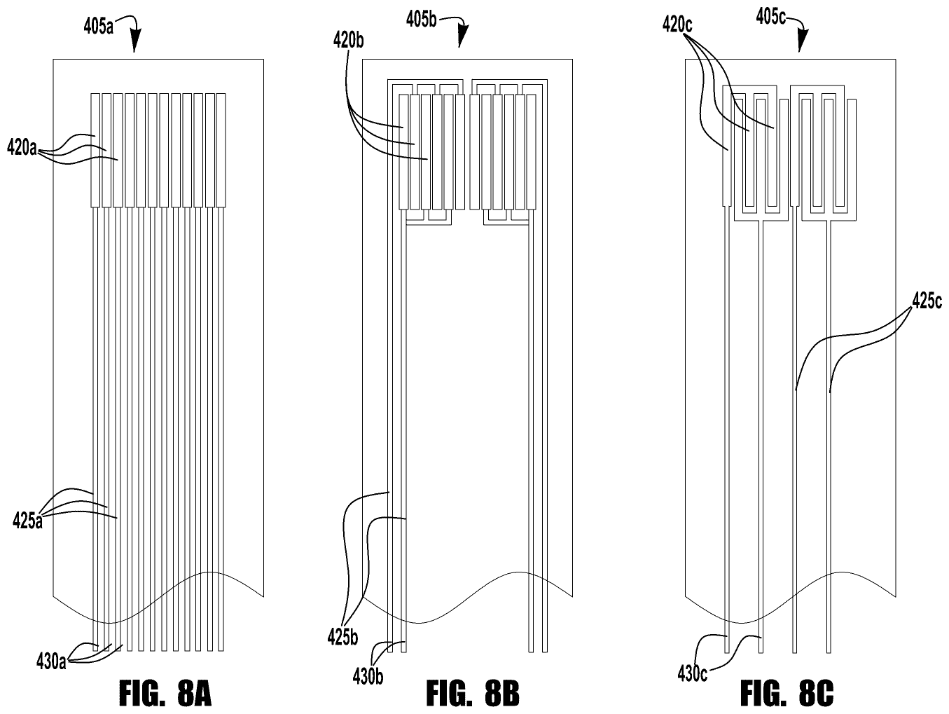

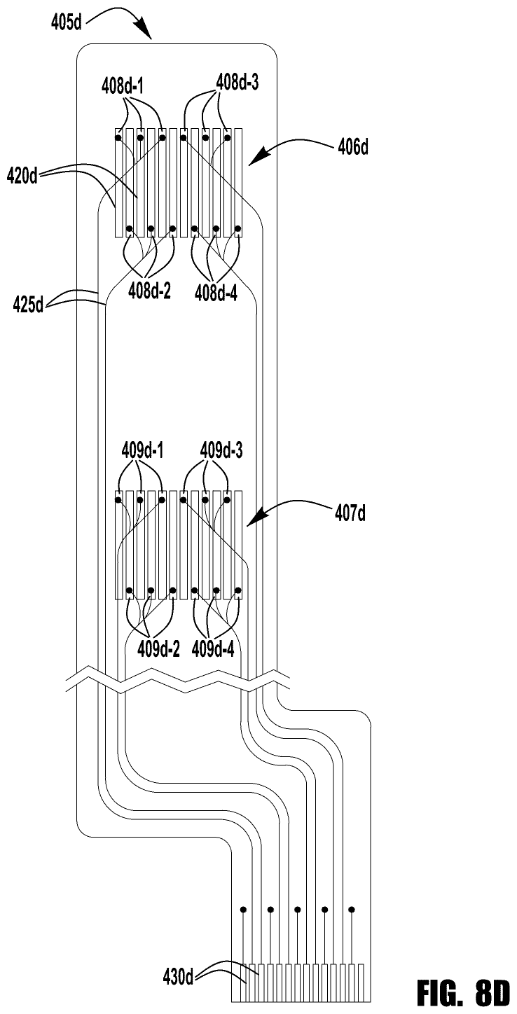

FIGS. 8A, 8B, and 8C illustrate exemplary flexible transducer arrays 405a, 405b, 405c adapted for use in a guided wave generating inspection device in accordance with aspects of the present disclosure, utilizing features of the above incorporated '299 Publication. The illustrated exemplary arrays 405a, 405b, 405c each include twelve electrodes 420a, 420b, 420c (e.g., linearly distributed on a surface of a layer of piezoelectric material opposite a substrate, as described above), with each electrode connected to an electrically conductive track 425a, 425b, 425c which extends to an associated electrical connector 430a, 430b, 430c. In the embodiment of FIG. 8A, the electrodes 420a are each independently or discretely wired or connected with the controlling electronics by a corresponding track 425a and connector 430a, such that each electrode in the array is individually operable/addressable by electrically driving/addressing the corresponding connector, which may provide selective and modifiable control of the electrodes. In the embodiments of FIGS. 8B and 8C, four interdigitated subarrays or subsets of electrodes 420b, 420c are connected to each other and a single corresponding track 425b, 425c and connector 430b, 430c to provide a single channel for each subset to simultaneously drive the electrodes of the subset to generate an ultrasonic signal, which may provide for simplified control electronics.

The array of electrodes 420 of the transducer 401 may be provided in a variety of suitable dimensions and configurations, including, for example a pitch (distance between electrode center lines) of between about 0.4 mm and about 1 mm, or between about 0.4 mm and about 0.6 mm), an elevation (length in the circumferential direction) of between about 3 mm and about 9 mm, a pitch width to gap ratio of about 4:1, and an electrode quantity of between 6 and 12.

In some applications, reflected response signals from emitted guided wave signals may exhibit variations dependent on the circumferential location on the transducer on the conduit, for example, due to an angled cut of the conduit end (which may produce indications of an un-bottomed condition at some circumferential locations and indications of partial or full bottoming at other circumferential locations). In accordance then with another aspect of the present disclosure, the inspection method may include the positioning of one or more transducers at a plurality of circumferential locations around the outer surface of the conduit, such that guided wave based inspection of the conduit fitting assembly may be performed at the plurality of circumferential locations to provide a more reliable and complete indication of the condition of the conduit fitting assembly. In some implementations, a tool having a single transducer may be repositioned (e.g., by user movement of the tool) around the circumference of the conduit one or more times during the inspection procedure to generate condition identifying ultrasonic signals at a plurality of circumferential locations. In other implementations, the tool may be designed to extend around a more significant portion of the conduit (e.g., greater than 180° of half of the circumference of the conduit) and may include a plurality of sets, rows, or banks of transducers circumferentially spaced around the conduit for simultaneous or sequential testing at the plurality of circumferential locations, without having to reposition the tool on the conduit.

FIG. 8D illustrates an exemplary flexible transducer array 405d including multiple sets, rows, or banks of transducers adapted for use in a guided wave generating inspection device in accordance with aspects of the present disclosure, utilizing features of the above incorporated '299 Publication. The illustrated exemplary array 405d includes two circumferentially spaced sets 406d, 407d of twelve electrodes 420d (e.g., linearly distributed on a surface of a layer of piezoelectric material opposite a substrate, as described above), with each electrode connected to an electrically conductive track 425d which extends to an associated electrical connector 430d. In the exemplary embodiment of FIG. 8D, each set 406d, 407d of electrodes includes four interdigitated subarrays or subsets 408d-1, 408d-2, 408d-3, 408d-4, 409d-1, 409d-2, 409d-3, 409d-4 of electrodes 420d (e.g., three electrodes per subset, as shown) connected to each other and to a single corresponding track 425d and connector 430d to provide a single channel for each subset to simultaneously drive the electrodes of the subset to generate an ultrasonic signal, which may provide for simplified control electronics. Another advantage of a transducer subset arrangement may be the ability to increase the strength of the signal generated by using multiple electrodes to simultaneously generate the signal.

While the interdigitated subsets of electrodes can both generate ultrasonic signals and receive ultrasonic signals, in some embodiments, one or more first subsets of electrodes of a transducer array can be exclusively used for signal generation and one or more second subsets of electrodes of the transducer array can be used to receive signals. In some embodiments, a device may be provided with multiple flexible transducer arrays (e.g., two of the flexible transducer arrays 405d of FIG. 8D), for example, to provide additional subsets of electrodes around the conduit engaging circumference of the tool (e.g., to allow the tool to identify different conditions (e.g., bottomed/un-bottomed) at different locations around the circumference of the conduit).

A variety of structures and arrangements may be utilized to reliably secure the transducer(s) to the conduit. In some implementations, the tool may include a tool body carrying the transducers and facilitating quick and reliable attachment and detachment of the tool on the conduit. For example, the tool body may include one or more contoured (e.g., arcuate) transducer carrying conduit engaging portions for applying the transducer to the conduit. As one example, a tool may include first and second hingedly connected clamp members biased (e.g., spring biased) towards a clamping condition in which contoured inner transducer carrying surfaces of the clamp members engage the outer surface of the conduit for engagement between the transducers and the conduit. The clamping forces provided by the clamp members may be selected to be sufficient to effectively impart ultrasonic signals to the conduit surface, and sufficient to hold the tool body in a fixed, stationary position on the conduit (e.g., resistant against bumping, gravitational forces, etc.), while limiting impact forces between the transducers and other clamp components and the conduit to prevent damage.

In some implementations, the transducer may be fixedly secured to the conduit engaging portion(s) of the tool, for uniform contact between the conduit engaging portion(s) and the conduit. In other implementations, the transducer may be movable with respect to the conduit engaging portion(s), for example, for conforming contact with the outer surface of the conduit end wall portion. The use of a flexible transducer (e.g., as shown in FIGS. 6-8D) movably secured with the conduit engaging portion(s) may provide for this type of movable conforming contact between the transducer and the outer surface of the conduit end wall portion.

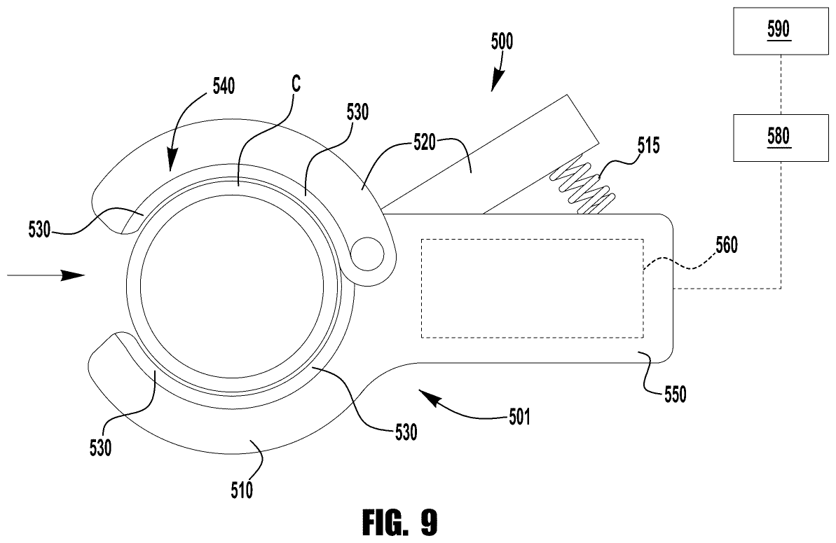

FIG. 9 schematically illustrates an exemplary clamping inspection tool 500 installed on a conduit C. The tool 500 includes a tool body 501 having first and second clamp members 510, 520 and one or more transducers 530 (e.g., the flexible transducers of FIGS. 6-8D) carried by either or both of the clamp members on contoured inner diameter surfaces of the clamp member(s). The clamp members 510, 520 are operatively (e.g., hingedly) connected (either directly or by intermediate component(s)) and movable (e.g., pivotable) between a clamping condition (as shown) holding the transducer(s) in engagement with the conduit C, and a releasing condition permitting removal of the tool 500 from the conduit. The clamp members 510, 520 may be biased (e.g., by spring element 515) towards a clamping condition in which contoured inner transducer carrying surfaces of the clamp members engage the outer surface of the conduit for engagement between the transducers and the conduit.

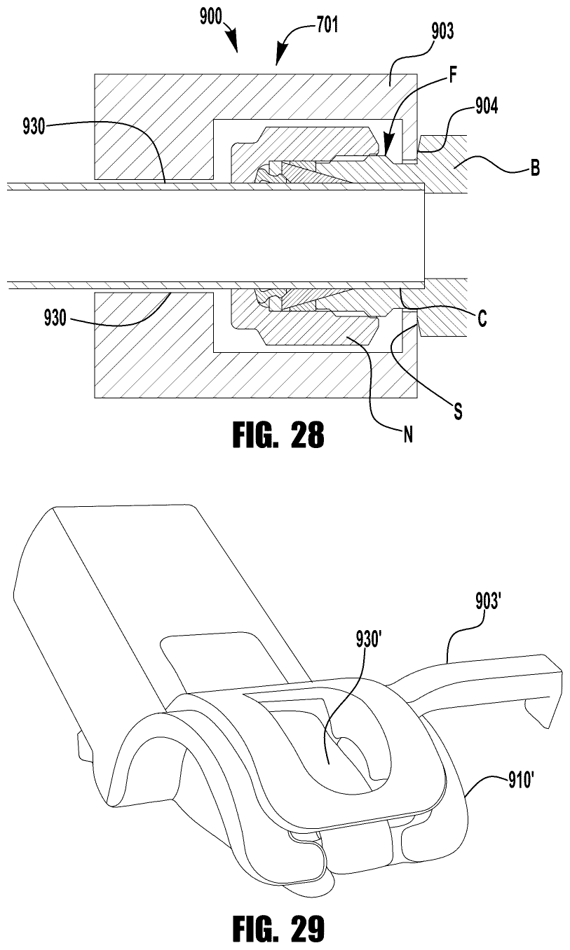

The flexible transducer(s) 530 may bend to conform with the contoured inner diameter surfaces of the clamp members 510, 520. To more reliably engage the conduit surface with the transducer(s) (e.g., to compensate for variations in conduit diameter, roundness, or surface irregularities), a layer of compressible backing material 540 (e.g., foam) may be provided between the transducer(s) and the more rigid clamp member surfaces. As described in greater detail below (and shown in FIGS. 28A-28D), the tool body 501 may also be provided with one or more attachable inserts to allow the clamp members 510, 520 to accommodate conduits of different diameters. Additionally or alternatively, tool bodies may be designed to be dedicated to a particular conduit size or range of sizes, such that a set of tool bodies may be provided for testing of a variety of conduits within a fluid system.

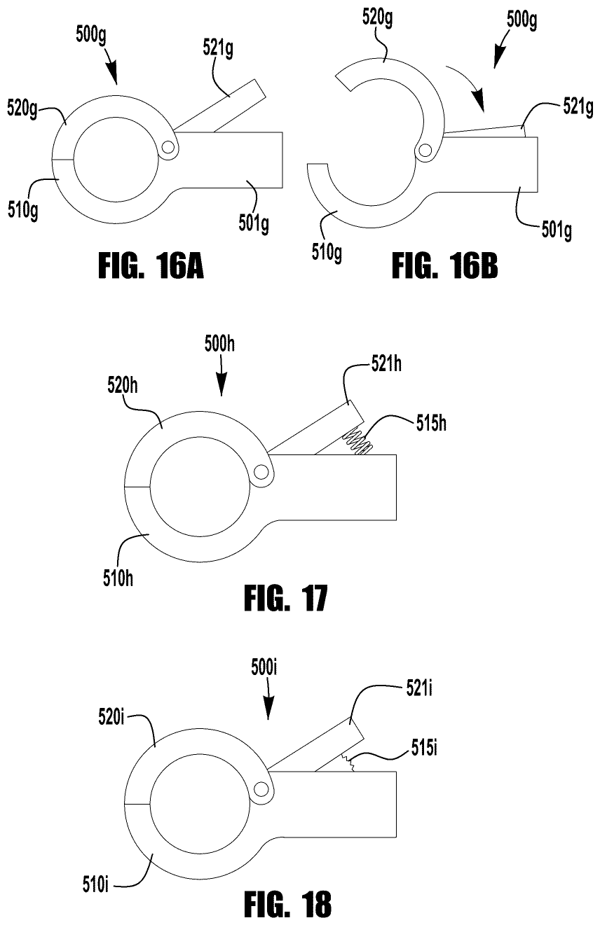

FIGS. 10A through 21 schematically illustrate a variety of different exemplary clamping arrangements which may be implemented or adapted for use with one or more of the inspection tools described herein.

FIGS. 10A and 10B illustrate an exemplary tool 500a including a first clamp member 510a integrally formed with the tool body 501a and a second clamp member 520a hingedly connected to the tool body, with a trigger element for pivotable movement between the clamping condition (FIG. 10A) and the releasing condition (FIG. 10B), similar to the tool 500 of FIG. 9.

FIGS. 11A and 11B illustrates another exemplary tool 500b including first and second clamp members 510b, 520b each hingedly connected to the tool body 501b for pivotable movement between the clamping condition (FIG. 11A) and the releasing condition (FIG. 11B).

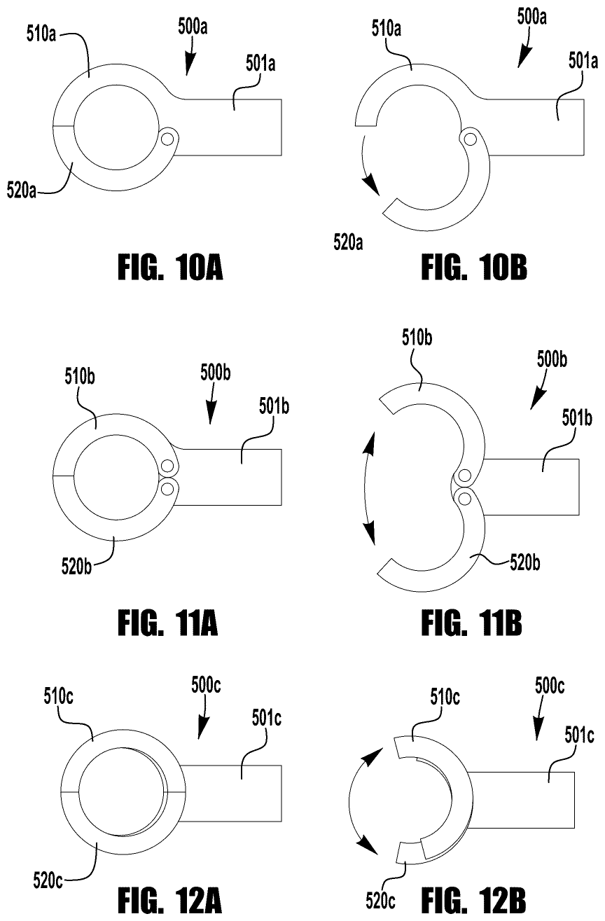

FIGS. 12A and 12B illustrates another exemplary tool 500c including first and second clamp members 510c, 520c each assembled with the tool body 501c for sliding movement between the clamping condition (FIG. 12A) and the releasing condition (FIG. 12B).

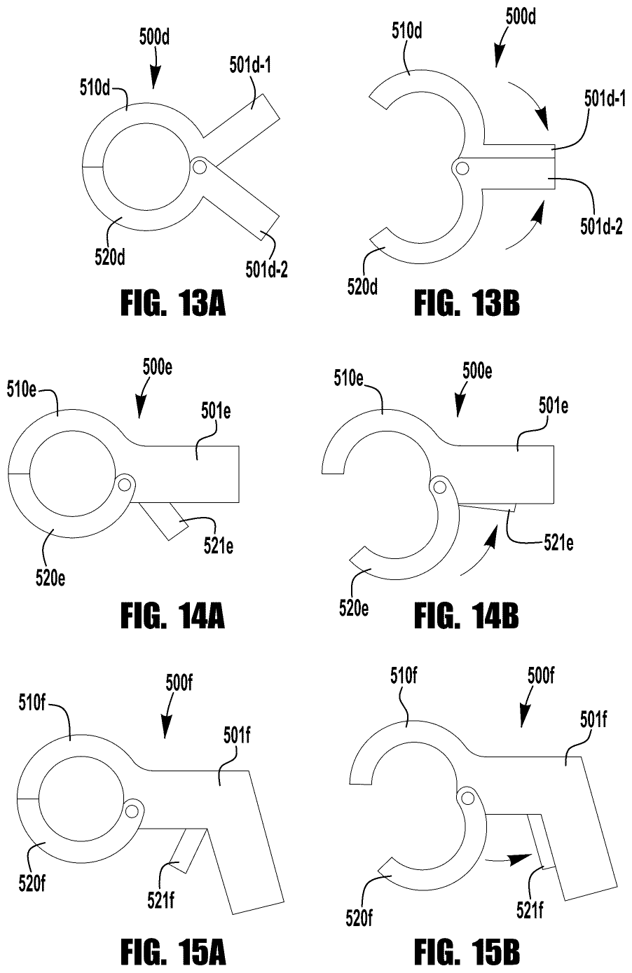

FIGS. 13A and 13B illustrates another exemplary tool 500d including first and second hingedly connected clamp members 510d, 520d each having body members 501d-1, 501d-2 that can be squeezed or pinched together for pivotable movement of the clamp members between the clamping condition (FIG. 13A) and the releasing condition (FIG. 13B).

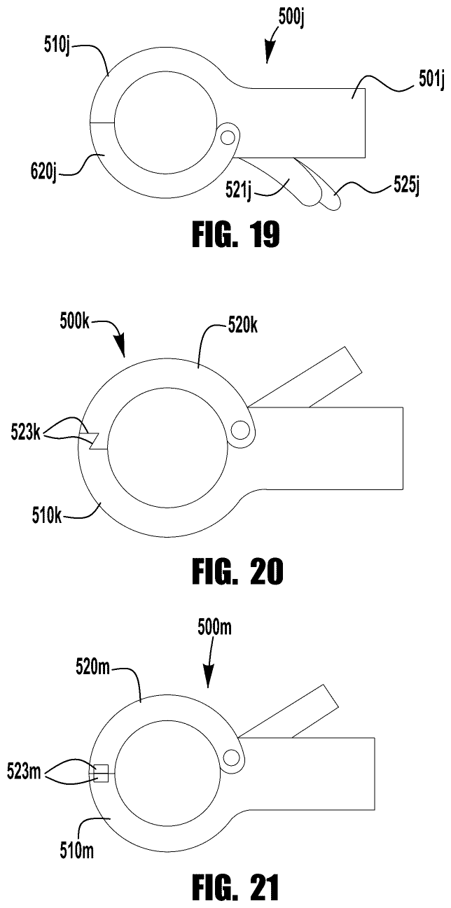

FIGS. 14A-14B, 15A-15B, and 16A-16B illustrate an exemplary tool 500e, 500f, 500g including a first clamp member 510e, 510f, 510g integrally formed with the tool body 501e, 501f, 501g and a second clamp member 520e, 520f, 520g hingedly connected to the tool body, with a trigger element 521e, 521f, 521g operable for pivotable movement of the second clamp element between the clamping condition (FIGS. 14A, 15A, 16A) and the releasing condition (FIGS. 14B, 15B, 16B), similar to the tool 500 of FIG. 9. As shown in FIG. 17, the trigger element 521h and second clamp member 520h may be spring biased (e.g., by spring element 515h) toward the clamping condition, similar to the tool 500 of FIG. 9. As shown in FIG. 18, the trigger element 521i may be provided with a ratcheting arrangement 515i, for example, to lock the second clamp member 520i in a desired clamping condition, which may be releasable for movement (e.g., spring biased movement) to the releasing condition, for example, using a quick release grip element 525j (FIG. 19) assembled with the tool body 501j.

Other arrangements may be used to secure the clamp members in a clamping condition, including, for example, interlocking detent teeth or clip portions 523k (FIG. 20) or magnetic elements 523m (FIG. 21) on the clamp members 510k, 510m, 520k, 520m.

Referring back to FIG. 9, the tool body may include an electronics housing 550, which may be integrated with one of the clamp members (e.g., with the first clamp member 510, as shown), or may be provided as a separate unit. The electronics housing may support, enclose, and/or protect an electronics package 560 of one or more electronic elements provided, for example, to supply power to the transducers, to initiate/drive electric signals to the transducers, to receive reflection response signals from the transducers, to process the received signals, to evaluate the processed signals, and/or to communicate processed signals or associated evaluations, for example, to a remote device or system.

In some embodiments, the tool 500 may be a self-contained ultrasonic testing device, with the electronics package 560 including all of the electronics elements, including, for example, a drive signal generator, a filter circuit for noise reduction of the received reflected signals, an analog to digital (A/D) converter for converting the electrical signal from the transducer into a digitized signal, a memory storage device for storing the digitized signal, a processor to facilitate interpretation of the data corresponding to one or more conditions of the conduit fitting assembly, and a user interface for communicating (e.g., display/visual and/or speaker/audible) the determined one or more conditions of the conduit fitting assembly. In some arrangements, the tool electronics package may include a wireless transceiver for wirelessly transmitting ultrasonic sensor test data to a remote computer device for further processing and/or reporting, and/or for receiving wireless command signals from a remote computer device. In some arrangement, the tool may include an internal battery unit to power the electronics package, for example, to eliminate the need for external wiring and/or an external power source.

In other embodiments, the electronics package 560 may be connected to an external hardware unit (shown schematically at 580), for example, by suitable wiring, which may include, for example, a cable connection for ease of replacement of the clamp device. In an exemplary embodiment, the wiring/cable provides transmit signals (power signals) to the transducer from the external hardware unit 580 and transmits the reflected signals back to the hardware unit, both of which are sent and received by the external hardware unit. In some arrangements, the tool electronics package 560 includes a filter circuit for noise reduction of the received reflected signals, and the external hardware unit 580 includes a drive signal generator, an analog to digital (A/D) converter for converting the electrical signal from the transducer into a digitized signal, a memory storage device for storing the digitized signal, a processor to facilitate interpretation of the data corresponding to one or more conditions of the conduit fitting assembly and a user interface for communicating (e.g., display/visual and/or speaker/audible) the determined one or more conditions of the conduit fitting assembly. In some arrangement, the external hardware unit 680 may include an internal battery unit to power the hardware unit, for example, to eliminate the need for external wiring to an external power source.

The external hardware unit 580 may be connected with (e.g., wired or wireless communication with) a computing device 590 (e.g., computer, tablet, smart phone) for evaluation, communication, and/or display of information corresponding to the received signals. In some arrangements, a memory storage device, data interpreting processor, and/or user interface provided in the computing device 590 may eliminate the need for one or more of these components in the external hardware unit 580, for example, to simplify the electronics in the external hardware unit.

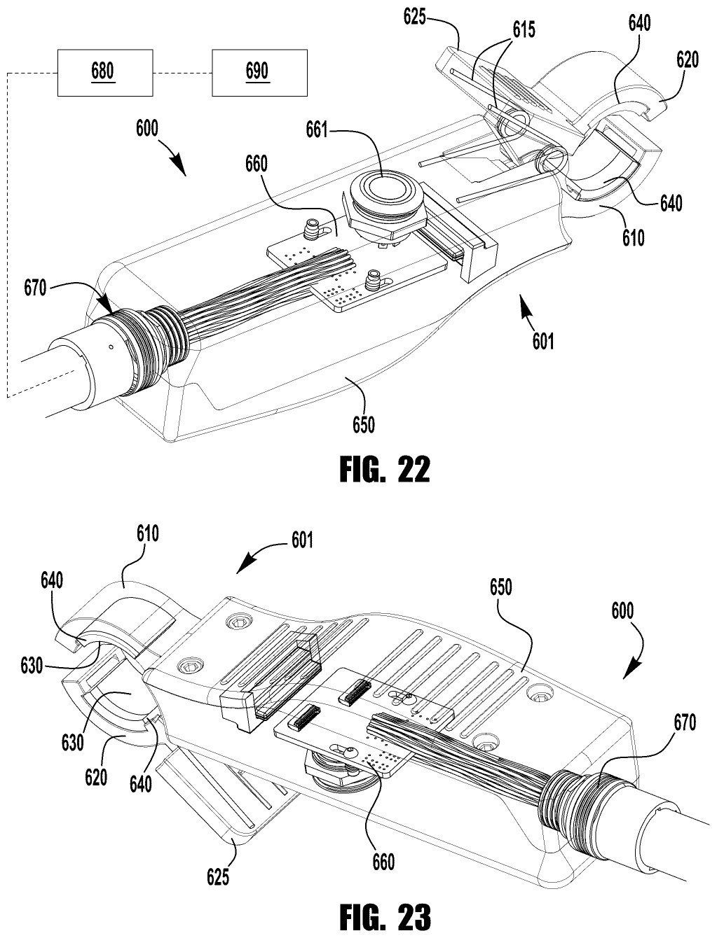

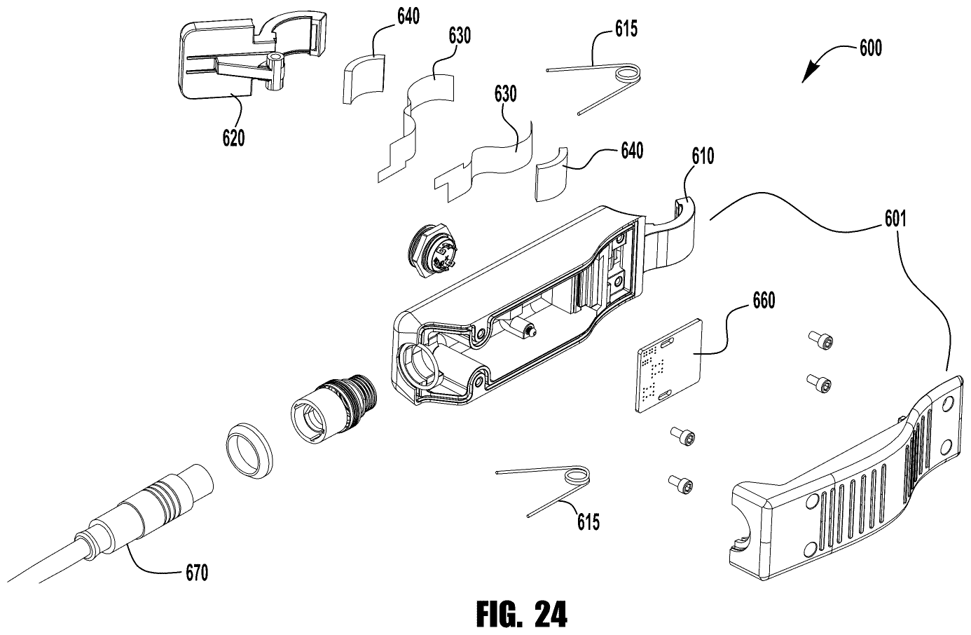

FIGS. 22-24 illustrate an exemplary clamping inspection tool 600 for installation on a conduit C. The tool 600 includes a tool body 601 having first and second arcuate clamp members 610, 620 and one or more transducers 630 (e.g., the flexible transducer boards of FIGS. 6-8) carried by either or both of the clamp members on contoured inner diameter surfaces of the clamp member(s). The clamp members 610, 620 are hingedly connected (either directly or by intermediate component(s)) and pivotable between a clamping condition (as shown) holding the transducer(s) in engagement with the conduit C, and a releasing condition permitting removal of the tool 600 from the conduit. The clamp members 610, 620 may be biased (e.g., by spring elements 615) towards a clamping condition in which contoured inner transducer carrying surfaces of the clamp members engage the outer surface of the conduit for engagement between the transducers and the conduit. A trigger or lever 625, which may be defined by the second clamp member 620, may be toggled or depressed to move the clamp members 610, 620 to the releasing condition.

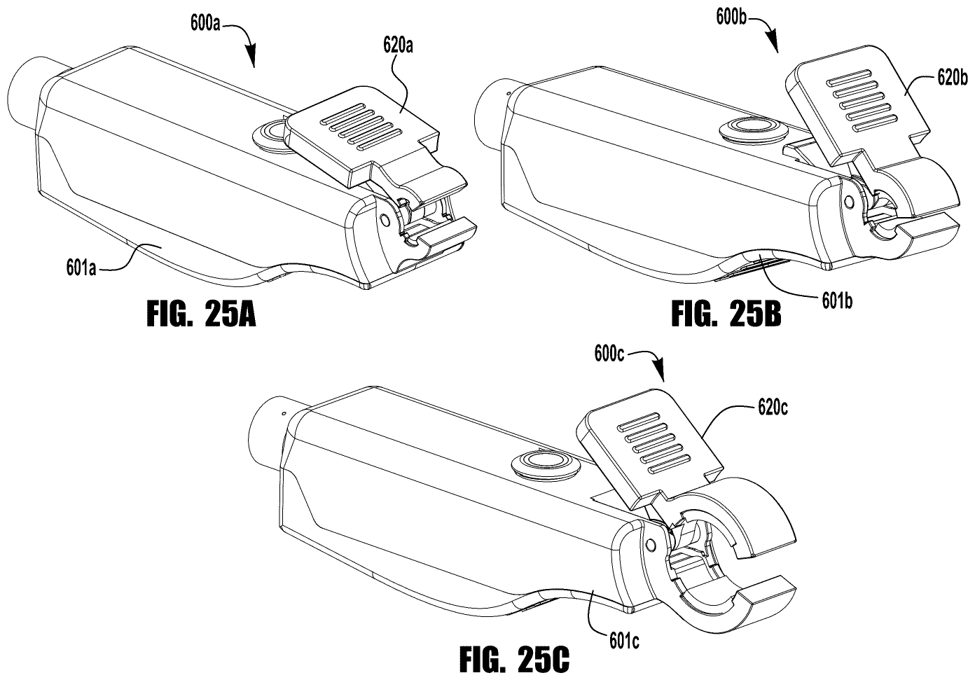

The flexible transducer board 630 may bend to conform with the contoured inner diameter surfaces of the clamp members 610, 620. To more reliably engage the conduit surface with the transducer(s) (e.g., to compensate for variations in conduit diameter, roundness, or surface irregularities), a layer of compressible backing material 640 (e.g., foam) may be provided between the transducer(s) and the more rigid clamp member surfaces. The tool body 601 may also be provided with one or more attachable inserts (not shown) to allow the clamp members 610, 620 to accommodate conduits of different diameters. Additionally or alternatively, tool bodies may be designed to be dedicated to a particular conduit size or range of sizes, such that a set of tools 600a, 600b, 600c having tool bodies 601a, 601b, 601c and hingedly connected clamp members 620a, 620b, 620c may be provided for testing of a variety of conduits within a fluid system, as shown in the embodiments of FIGS. 25A, 25B, and 25C. In some embodiments, the tool bodies or attachable inserts may be provided with discrete projections or pads that allow for a degree of flexure (or other tolerance deviations) of the conduit that may be accommodated.

Referring back to FIGS. 22-24, the tool body 601 may include an electronics housing 650, which may be integrated with one of the clamp members (e.g., with the first clamp member 610, as shown), or may be provided as a separate unit. The electronics housing 650 may support, enclose, and/or protect an electronics package 660 of one or more electronic elements connected to the connectors of the transducers 630 and provided, for example, to supply power to the transducers, to initiate/drive electric signals to the transducers, to receive reflection response signals from the transducers, to process the received signals, to evaluate the processed signals, and/or to communicate processed signals or associated evaluations, for example, to a remote device or system.

In some embodiments, the tool may be a self-contained ultrasonic testing device, with the electronics package 660 including a drive signal generator, a filter circuit for noise reduction of the received reflected signals, an analog to digital (A/D) converter for converting the electrical signal from the transducer into a digitized signal, a memory storage device for storing the digitized signal, a processor to facilitate interpretation of the data corresponding to one or more conditions of the conduit fitting assembly, and a user interface for communicating (e.g., display/visual and/or speaker/audible) the determined one or more conditions of the conduit fitting assembly. In some arrangements, the tool electronics package may include a wireless transceiver for wirelessly transmitting ultrasonic sensor test data to a remote computer device for further processing and/or reporting, and/or for receiving wireless command signals from a remote computer device. In some arrangement, the tool may include an internal battery unit to power the electronics package, for example, to eliminate the need for external wiring and/or an external power source (e.g., eliminating cable 670).

In other embodiments, the electronics package 660 may be connected to an external hardware unit (shown schematically at 680 in FIG. 22), for example, by suitable wiring 670, which may include, for example, a cable connection for ease of replacement of the clamp device. In an exemplary embodiment, the wiring/cable 670 provides transmit signals (power signals) to the transducer from the external hardware unit 680 and transmits the reflected signals back to the hardware unit, both of which are sent and received by the external hardware unit. In some arrangements, the tool electronics package 660 includes a filter circuit for noise reduction of the received reflected signals, and the external hardware unit 680 includes a drive signal generator, an analog to digital (A/D) converter for converting the electrical signal from the transducer into a digitized signal, a memory storage device for storing the digitized signal, a processor to facilitate interpretation of the data corresponding to one or more conditions of the conduit fitting assembly and a user interface for communicating (e.g., display/visual and/or speaker/audible) the determined one or more conditions of the conduit fitting assembly. In some arrangement, the external hardware unit 680 may include an internal battery unit to power the hardware unit, for example, to eliminate the need for external wiring to an external power source.

The external hardware unit 680 may be connected with (e.g., wired or wireless communication with) a computing device 690 (e.g., computer, tablet, smart phone) for evaluation, communication, and/or display of information corresponding to the received signals. In some arrangements, a memory storage device, data interpreting processor, and/or user interface provided in the computing device 690 may eliminate the need for one or more of these components in the external hardware unit 680, for example, to simplify the electronics in the external hardware unit.

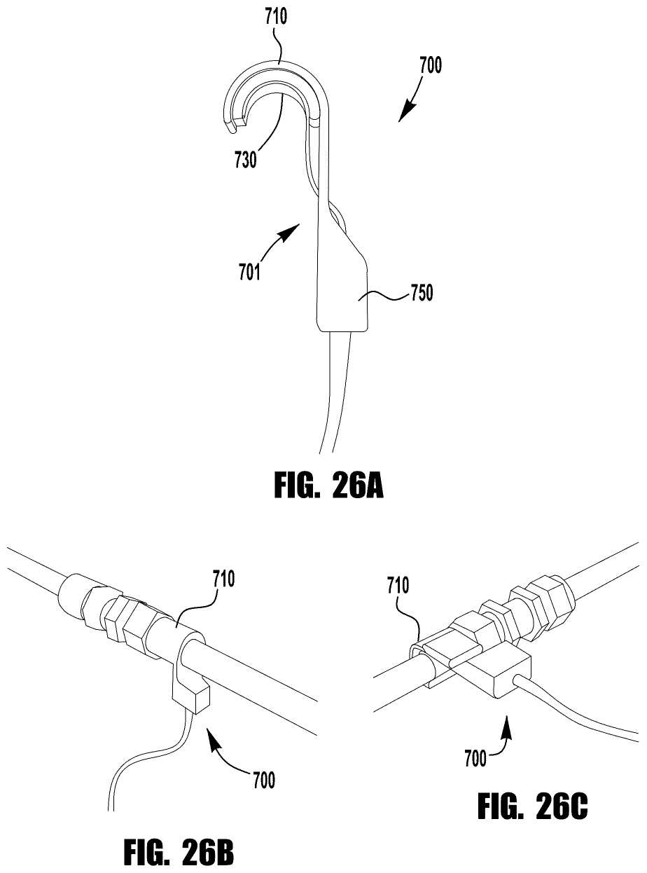

While the embodiments of FIGS. 10A through 25C include clamping arrangements having two clamp members carrying transducers for mating engagement with the conduit surface, in other embodiments, a single transducer bearing member is provided with one or more transducers for engagement with the conduit surface. FIGS. 26A, 26B, and 26C illustrate an exemplary inspection tool 700 similar to the tool 600 of FIGS. 22-24 but including a body 701 having a single hook-shaped portion 710, with one or more transducers 730 (e.g., the flexible transducers of FIGS. 6-8) carried by the hook-shaped member on contoured inner diameter surfaces of the hook-shaped member. The hook-shaped portion 710 may be sized to hook around the conduit, and may be adaptable (e.g., using inserts/adapters) for hooked engagement with a range of conduit sizes. In some arrangements, the hook-shaped portion 710 may be elastically flexible, for example to flex around and provide a degree of gripping or clamping engagement with the conduit, for example, to prevent loose movement of the tool on the conduit. In other embodiments, the weight of the tool 700 (e.g., at an electronics housing 750 portion of the body 701) may be sufficient to hold the hook-shaped member 710 in a stationary position. In some applications, reduced gripping or clamping force between the tool body 701 and the conduit may facilitate repositioning of the tool on the conduit, for example, repositioning around the circumference of the conduit to facilitate multiple ultrasonic signal tests around the conduit circumference by a tool having a single transducer, as described above.

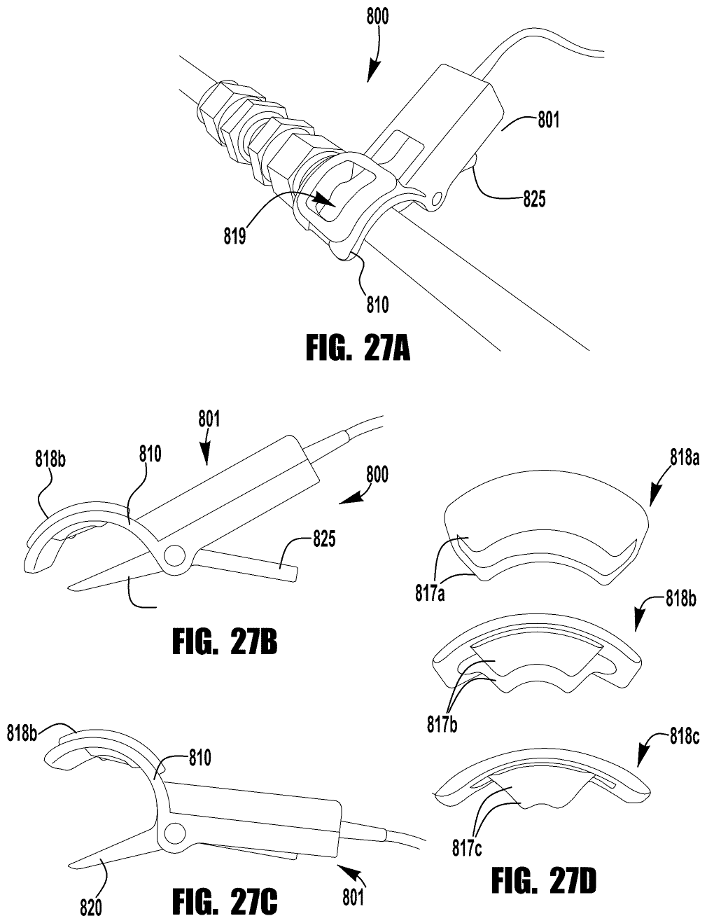

FIG. 27A-27D illustrate another exemplary inspection tool 800 similar to the tool 600 of FIGS. 22-24 but including a tool body 801 having a first, transducer bearing arcuate clamp member 810 contoured to closely fit around the conduit, and a second, non-transducer bearing clamp member 820 hingedly connected to the first clamp member (either directly or by intermediate component(s)) and pivotable between a clamping condition holding the transducer(s) in engagement with the conduit C, and a releasing condition permitting removal of the tool 800 from the conduit. The clamp members 810, 820 may be biased (e.g., by spring elements, not shown) towards a clamping condition in which contoured inner transducer carrying surfaces of the first clamp member engages the outer surface of the conduit for engagement between the transducers and the conduit, with the inner surface of the second clamp member engaging the outer surface of the conduit to hold the first clamp member in place. As shown, a separate release trigger 825 may be provided to move the clamp members 810, 820 to the releasing condition (e.g., by disengaging one or more biasing members from the second clamp member).

The clamp member 810 may be provided with one or more attachable inserts 818a, 818b, 818c to allow the tool 800 to accommodate conduits of different diameters, for example, by providing conduit engaging surfaces of different contours and dimensions. While many different types of attachment may be utilized, in the illustrated example, the insert includes side walls 817a, 817b, 817c insertable through a central slot 819 in the first clamp member 810, and may be flexible enough to snap into engagement with the first clamp member. The inserts may include central openings sized to accommodate the flexible transducer and associated electrical connectors.

In some embodiments, the inserts may include conduit engaging surfaces that contact the conduit outer surface to function as a hard stop, thereby limiting force between the conduit and the transducer(s), and/or compression of the transducer backing material (where used). In other embodiments, the inserts may additionally or alternatively include transducer bearing surfaces configure to flex and position the flexible transducer membrane(s) into a shape selected to provide conforming contact with the outer surface of the conduit.

Other features may additionally or alternatively be provided. For example, referring back to FIGS. 22-24, the tool 600 may be provided with a switch (e.g., depressible button) 661 in electrical communication with the electronics package 660 to allow for user initiation of an inspection test in response to activation of the switch. In other arrangements, one of the clamp members may be provided with a switch or sensor configured to be activated when the clamp members are applied in clamping engagement with the conduit (and/or when a gauging surface of the tool is in abutment with a surface of the fitting (as described below), for automatic initiation of an inspection test upon assembly of the inspection device with the conduit fitting assembly.

As another example, the inspection tool may be provided with an output signaling element (light, screen, speaker) to generate an alert when the inspection test is complete, when the inspection test identifies an improper fitting assembly, and/or when the inspection tool is improperly coupled to the conduit fitting assembly (such that the inspection test cannot be reliably completed). Such output signal can be provided as a light (e.g., LED with appropriate light pipe) around the button for example, or light on the associated hardware or on the display of the computer device. The light may be adapted to communicate multiple conditions, for example, distinguishable by light color, intensity, duration, and/or flashing sequence. In some applications, a liquid or gel may be applied to the conduit surface as a coupling layer to enhance the electrode engagement with the conduit surface—a user alert regarding improper tool engagement may provide a prompt, for example, to apply additional liquid/gel and/or to reposition the sensor.

The clamping engagement between the transducers and the conduit surface may provide predictable and repeatable radial positioning of the transducers on the conduit (with respect to the central axis of the conduit), and the retention of the transducers on the clamping member(s) may provide predictable and repeatable circumferential spacing of the transducers around the cylindrical surface of the conduit. According to another aspect of the present disclosure, the tool body of the inspection tool may provide for predictable axial positioning of the transducers on the conduit, relative to the conduit fitting, for example, to position the transducers at a known, gaugable axial distance from the one or more features (e.g, the ferrule(s), the bore shoulder against which the conduit should be bottomed, etc.). In some embodiments, the transducers may be properly axially positioned by bringing an end surface of the tool body into abutment with an end face of the conduit fitting. In other applications, a conduit fitting may include an endmost component (e.g., the nut of a tube fitting) that axially moves during pull up, potentially affecting the gaugability of the fitting end surface with respect to other portions of the fitting.

FIG. 28 schematically illustrates a conduit fitting assembly F provided with an inspection tool 900 that includes a tool body 901 secured to the conduit and having a gauge arm or extension 903 extending axially from the tool body 901, over and axially beyond the adjustable nut N of the conduit fitting F, such that a gauge surface 904 of the gauge arm contacts a radially extending surface (e.g., shoulder) S of the fitting body B for axial positioning of the transducer(s) 930 with respect to the fitting body. A variety of gage arm/extension structures may be utilized. FIG. 29 illustrates an exemplary clamp member 910′ including a gauge arm 903′ removably attachable to the clamp member, for example, to allow for attachment of different length gauge arms for use with different size/type fitting assemblies. As shown, the attachment of the gauge arm 903′ to the clamp member 910′ may be similar to the attachment of the inserts 818a, 818b, 818c to the first clamp member 810 of the tool 800 of FIGS. 27A-27D. In some embodiments, the gauge arm insert may also include conduit engaging surfaces for adapting the clamp member to fit a variety of conduit sizes.

In operating an ultrasonic conduit fitting assembly inspection tool, such as, for example, one or more of the exemplary inspection tools described herein, the reflected signals received by the transducer(s) may be processed and evaluated to determine a variety of conditions of the conduit fitting assembly. The discernment of one or more of these conditions may utilize machine learning or artificial intelligence (AI) to simplify interpretation of signal data (e.g., determination of one or more acceptable or non-acceptable conditions, or identification of inconclusive results), and may involve one or more of a number of AI algorithms and/or a training mode, to learn common characteristics of the reflected signals for a variety of known conditions. Exemplary identifiable conditions include, for example, conduit diameter, conduit wall thickness, conduit material, conduit material discontinuities, a fully bottomed condition of the installed conduit end, a partially bottomed condition of the installed conduit end, an un-bottomed condition of the installed conduit end, a location of an unbottomed portion relative to the body or ferrule position, a ferrule/conduit gripping member bite (or absence of a bite) consistent with proper pull-up, a ferrule/conduit gripping member bite (or absence of a bite) consistent with insufficient pull-up, a ferrule/conduit gripping member bite consistent with overtightening, a ferrule/conduit gripping member bite consistent with improper ferrule installation (e.g., incorrect orientation, incorrect quantity, and/or incorrect size or material of ferrule components), proper electrode engagement with the conduit, and improper electrode engagement with the conduit. Additionally or alternatively, the inspection tool may allow for user input/identification of known conditions (e.g., conduit material, conduit diameter, conduit wall thickness) to facilitate grouping of the received test data signals with groups of stored data signals corresponding to these known conditions.

The use of machine learning and/or artificial intelligence (AI) may be employed to provide additional enhancements and improvements to evaluations of fitting assembly conditions. For example, multiple frequencies options can be used and incorporated into the hardware, software and sensor to provide the ability to assess a more effective or optimum configuration for enhancing signal penetration and accuracy depending on the fitting characteristics. The adaptable arrangement could include custom tools for different frequencies for example or even transducer arrangements with different arrays built into the same tool, providing the option to vary the sent signal and received response parameters using the same tool/transducer configuration. This may, for example, provide the ability to enhance the signal and response resulting in better accuracy for the fitting condition or geometry characteristics.

In some implementations, convolutional neural network (CNN) algorithms may be used to identify characteristics of the fitting assembly, such as, for example, improper or incomplete fitting assembly, as described herein and in the above incorporated '445 patent.

In some implementations, machine learning models and/or artificial intelligence (AI) may use historical data for analysis of a fitting assembly over time to predict or diagnose wear, loosening, leakage, or other service conditions, for example, to facilitate proactive maintenance scheduling for the fitting assembly.

In other implementations machine learning models and/or artificial intelligence (AI) may use the ultrasonic test data collected by the tool in combination with other system sensors, such as, for example, pressure, temperature, and/or flow sensors, to provide more thorough, reliable, and/or accurate analysis and diagnosis. These additional sensors may be integrated into the ultrasonic testing tool, or may be provided in a separate component.

In some implementations, a data evaluating processor may use the received signals to generate a digital image representing characteristics of the signal received which may include, for example, graphical representations of individual array or sub array responses, including signal strength, time and/or distance traveled. Signals may be filtered, amplified or combined for example to create a digital pattern or graphical representation of the reflected plurality of ultrasonic signals to identify signal strength and distance traveled of the reflected plurality of ultrasonic signals. The generated graphical representation may be compared to a plurality of stored graphical representations corresponding to a plurality of possible conditions of the least one of the conduit fitting and the conduit end, including one or more of the conditions described herein. For example, the generated graphical representation may include a portion or portions corresponding to at least one of a location of an end face of the conduit end, a degree of bottoming of the conduit end, a location of a ferrule bite on the conduit end, and a degree of ferrule bite on the conduit end. In some implementations, a machine learning and/or artificial intelligence (AI) algorithm may be used to identify characteristics of the assembled fitting from one or more sensor array or sub-arrays based on these signal strength, time, and/or distance travelled parameter.

The inventive aspects have been described with reference to the exemplary embodiments. Modification and alterations will occur to others upon a reading and understanding of this specification. It is intended to include all such modifications and alterations insofar as they come within the scope of the appended claims or the equivalents thereof.

1. A method of inspecting a conduit fitting installed on a conduit end, the conduit fitting comprising a fitting body defining a central bore receiving the conduit end, the method comprising:
providing a transducer secured to a wall portion of the conduit end;
operating the transducer to apply a plurality of ultrasonic signals against an outer surface of the conduit end wall portion at a plurality of axial locations spaced apart from the central bore by a plurality of different distances, such that the plurality of ultrasonic signals are guided axially along the conduit end wall portion into the central bore of the conduit fitting and reflected axially back to the transducer; and
evaluating the reflected plurality of ultrasonic signals to identify a condition of at least one of the conduit fitting and the conduit end.

2. The method of claim 1, wherein operating the transducer to apply the plurality of ultrasonic signals comprises directing the plurality of ultrasonic signals in a direction perpendicular to the outer surface.

3. The method of claim 1, wherein operating the transducer to apply the plurality of ultrasonic signals comprises applying the plurality of ultrasonic signals at a frequency of between about 2.2 MHz and about 5 MHz.

4.-12. (canceled)

13. The method of claim 1, wherein evaluating the reflected plurality of ultrasonic signals comprises processing the reflected plurality of ultrasonic signals and transmitting the processed signals to a remote computer device.

14. The method of claim 1, wherein the condition of the at least one of the conduit fitting and the conduit end comprises at least one of: conduit diameter, conduit wall thickness, conduit material, conduit material discontinuities, a fully bottomed condition of the installed conduit end, a partially bottomed condition of the installed conduit end, an un-bottomed condition of the installed conduit end, a location of an unbottomed portion relative to the body or ferrule position, a ferrule/conduit gripping member bite (or absence of a bite) consistent with proper pull-up, a ferrule/conduit gripping member bite (or absence of a bite) consistent with insufficient pull-up, a ferrule/conduit gripping member bite consistent with overtightening, a ferrule/conduit gripping member bite consistent with improper ferrule installation (e.g., incorrect orientation, incorrect quantity, and/or incorrect size or material of ferrule components), proper transducer element engagement with the conduit, and improper transducer element engagement with the conduit.

15.-19. (canceled)

20. The method of claim 1, wherein evaluating the reflected plurality of ultrasonic signals to identify the condition of the least one of the conduit fitting and the conduit end comprises generating a graphical representation of the reflected plurality of ultrasonic signals to identify signal strength and distance traveled of the reflected plurality of ultrasonic signals.

21. The method of claim 20, wherein evaluating the reflected plurality of ultrasonic signals to identify the condition of the least one of the conduit fitting and the conduit end comprises comparing the generated graphical representation to a plurality of stored graphical representations corresponding to a plurality of possible conditions of the least one of the conduit fitting and the conduit end.

22. The method of claim 20, wherein the generated graphical representation includes a portion corresponding to at least one of: a location of an end face of the conduit end, a degree of bottoming of the conduit end, a location of a ferrule bite on the conduit end, and a degree of ferrule bite on the conduit end.

23.-52. (canceled)

53. A system for inspecting a conduit fitting installed on a conduit end, the conduit fitting comprising a fitting body defining a central bore receiving the conduit end, the system comprising:
a tool including a tool body carrying a transducer and configured to be assembled with at least one of the conduit fitting and the conduit end to secure the transducer to an outer surface of a wall portion of the conduit end;
wherein the transducer includes a plurality of axially spaced transducer elements configured to apply a plurality of ultrasonic signals against the outer surface of the conduit end wall portion at a plurality of axial locations spaced apart from the central bore by a plurality of different distances, such that the plurality of ultrasonic signals are guided axially along the conduit end wall portion into the central bore of the conduit fitting and reflected axially back to the transducer.

54. The system of claim 53, wherein the plurality of axially spaced transducer elements are positioned to apply the plurality of ultrasonic signals in a direction perpendicular to the outer surface.

55. (canceled)

56. The system of claim 53, wherein the plurality of axially spaced transducer elements are operable to receive the reflected plurality of ultrasonic signals.

57. The system of claim 53, wherein the transducer comprises a flexible printed circuit board (PCB) carrying the plurality of axially spaced transducer elements.

58. (canceled)

59. The system of claim 53, wherein the plurality of axially spaced transducer elements comprises a first set of transducer elements operable to transmit the plurality of ultrasonic signals and a second set of transducer elements operable to receive the reflected plurality of ultrasonic signals.

60. The system of claim 53, wherein the plurality of axially spaced transducer elements comprises a first set of transducer elements and a second set of transducer elements circumferentially spaced apart from the first set of transducer elements.

61. (canceled)

62. The system of claim 60, wherein the transducer comprises a first flexible printed circuit board (PCB) carrying the first sets of transducer elements and a second flexible PCB carrying the second set of transducer elements.

63. (canceled)

64. The system of claim 53, wherein the tool includes a clamping portion defining a conduit engaging portion, the transducer being secured to the conduit engaging portion.

65.-66. (canceled)

67. The system of claim 53, wherein the transducer comprises a flexible printed circuit board (PCB) secured to a conduit engaging portion of the tool, wherein the flexible PCB is movable with respect to the conduit engaging portion for conforming contact with the outer surface of the conduit end wall portion.

68. The system of claim 53, wherein the transducer is secured to a conduit engaging portion of the tool by a compressible backing material for conforming contact with the outer surface of the conduit end wall portion.

69. The system of claim 53, wherein the tool includes a detachable insert securable to the tool body and defining a conduit engaging portion, wherein the detachable insert is a first detachable insert and the conduit engaging portion is a first conduit engaging portion sized for engagement with a first conduit having a first diameter, the system further comprising a second detachable insert securable to the tool body and defining a second conduit engaging portion sized for engagement with a second conduit having a second diameter different from the first diameter.

70.-78. (canceled)

79. A system for inspecting a conduit fitting installed on a conduit end, the conduit fitting comprising a fitting body defining a central bore receiving the conduit end, the system comprising:
a tool including a tool body carrying a transducer and configured to be assembled with at least one of the conduit fitting and the conduit end to secure the transducer to an outer surface of a wall portion of the conduit end;
wherein the transducer includes at least one transducer element configured to apply at least one radial ultrasonic signal against the outer surface of the conduit end wall portion, such that the at least one radial ultrasonic signal is guided radially through an annular wall of the conduit end and reflected radially back to the transducer, and to apply at least one axial ultrasonic signal against the outer surface of the conduit end wall portion, such that the at least one axial ultrasonic signal is guided axially along the conduit end wall portion into the central bore of the conduit fitting and reflected axially back to the transducer.

80.-115. (canceled)
